(19) United States
(12) Patent Application Publication
(10) Pub. No.: US 2009/0204479 A1
(43) Pub. Date: Aug. 13, 2009

(54) SYSTEM AND METHOD FOR CREATING AN IN-STORE MEDIA NETWORK USING TRADITIONAL MEDIA METRICS

(75) Inventors: Robert I. Wolinsky, Fairfield, CT (US); John Lunghi, Fairfield, CT (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Automated Media Services, Inc.

(21) Appl. No.: 12/368,232

(22) Filed: Feb. 9, 2009

Related U.S. Application Data
(60) Provisional application No. 61/065,063, filed on Feb. 8, 2008.

(51) Int. Cl. G06Q 30/00; H04N 7/025; H04N 7/18; G06Q 10/00

(52) U.S. Cl. 705/10; 725/32; 725/78; 705/14

(57) ABSTRACT

A system and method for selling advertising may include operating an electronic display network operating in a retail store. The network may include electronic displays interspersed among product displays and arranged to present a shopper with each advertisement among multiple repeating advertisements a predicted number of multiple times as a function of shopper metrics and a configuration of the electronic display network during a shopping trip in the retail store. Airtime may be sold to an advertiser for an advertisement to be displayed on the electronic display network.

### CROSS-REFERENCE TO RELATED APPLICATIONS

This applications claims priority to co-pending U.S. Provisional Patent Application Ser. No. 61/065,063, filed on Feb. 8, 2008, which is incorporated herein by reference in its entirety.

### DESCRIPTION OF RELATED ART

Marketers of goods and services advertise to inform and influence the buying decisions of both existing and potential consumers of their products. They also work to find the most effective media in which to advertise their goods and services. Typically, these companies hire advertising agencies to determine the most effective messages and means, or medium, to reach these consumers. Print media, such as newspapers and magazines, and broadcast media, such as radio and television (regardless of whether received as broadcasts, or via alternate means such as cable, or satellite) and more recently the Internet have all been effectively used to advertise products and services that are or will be available for consumption. Of all forms of media used by advertisers, television has traditionally been the most dominant medium because of its ability to efficiently deliver mass audiences and the persuasive nature of video. Within television, advertisers, and agencies, strive to find the most effective program, channel, time slot, among other parameters, that can provide the marketer with the most targeted mass audience for its goods and services. For example, a diaper company would likely seek to advertise on daytime programming when housewives (i.e., most potential purchasers of diapers) are watching television.

As television, including broadcast, cable, and satellite television networks, has grown, so has the cost of advertising on this media. To enable advertisers and their agencies to determine audience size and demographics, an audience measurement system has evolved based on recording the viewing habits of a small representative sample of the total potential television audience. In part, based on sample data and various interpretations of the data, media networks and analysis companies determine appropriate analytical tools, “media metrics” to set the price and availability of advertising airtime. The media metrics use mathematics to, in part, to establish a common set of metrics useful for determining such factors as audience reach, share of audience, household viewership, ratings, and other relevant data that aid in the purchase of airtime. A single rating point can represent one percent of the total number of television households in a market, or represent audience reach as a defined number-set. Share is the percentage of television sets in use tuned to a particular program. For example, Nielsens' measurement rating service, may report a given program “ratings” within a particular market as receiving a 9.2/15 (rating/share) during its broadcast, meaning that on average 9.2 percent of households were tuned-in, and 15 percent of all televisions in use in the market at the time were tuned into this program. Nielsen re-estimates the total number of households each August for the upcoming television season. This analysis, or rating, forms the basis of how the networks set their selling price in CPM (cost per thousand viewers) for airtime on specific programs. Additionally, viewer demographics, such as age, sex, economic class, and geographic area airtime influence CPM rates. Ratings are a statistical assessment based on sample data (sampling), the actual audience size is therefore unknown. Such rating methodology permits programs to get 0.0 rating, despite having an audience; the CNBC talk show McEnroe was one notable example. Advertising agencies utilize the aforementioned metrics to access the media marketplace to purchase media in a unit of measure called a “Gross Rating Point” (GRP). The definition of a GRP is audience reach times frequency of view (i.e., GRP=reach×frequency). Reach is the size of the audience who listens to, reads, views, or otherwise accesses a particular work, such as an advertisement, in a given period. Frequency is the average number of times a person has been exposed to a commercial or advertisement message during a given period of time. These standardized media metrics allow agencies to purchase substantial amounts of airtime across multiple programs on multiple networks according to a predefined strategy based on acquisition of GRP units.

Planned Media is the term used to identify media platforms with similarly standardized platform specific measurement metrics, like radio and magazines. However, in recent years, industry indicators point to diminishing effectiveness of television advertising due to multiple factors. First, television has become an ever more fragmented market. No longer are there only three networks from which viewers may choose as there are now literally hundreds from which to choose on cable and satellite television. This increase in available programming has significantly reduced the reach of any single program. Consequently, agencies have to analyze many more networks and purchase substantially more airtime to deliver media planners' requisite GRPs. Simultaneously, CPM rates are rising as networks have to support their programming costs over smaller audience delivery. Second, the proliferation of digital video recorders (e.g., TiVo®, DVRs) that enable viewers to record television shows and simply skip over the advertisements and, as a result, reduce the reach of advertisements, thereby raising cost for advertisers. Third, trends have shown that the overall viewing audience for television has become smaller due to media fragmentation, demographic changes, media proliferation, and other factors, such as the proliferation of the Internet among all age brackets, especially younger age brackets.

One factor that further concerns marketers is the inability to determine the effectiveness of television advertising. A marketer that advertises on television is hard-pressed to determine whether consumers who have seen the advertising are purchasing their goods or services as a direct result of the advertising. Still yet, since marketers, or their agents, purchase airtime for their ads before the program airs, the CPM rate and audience delivery are determined on a projection of the expected audience delivery. When viewership or program ratings are later reported, there is often an under-delivery of viewers, which often times causes the network to provide an airtime credit to the advertiser. In an effort to have a more direct and easily measurable influence on consumers, marketers have used promotional advertising techniques directly in the business establishments that are actually selling their goods and services.

Traditionally, advertising in business establishments, such as retail stores, gas stations, members of a retail business association, movie theaters, etc., is classified as “sales promotion.” Sales promotion is generally, further subdivided into two groups: (i) consumer promotion—targeting consumers, and (ii) retail trade promotion—targeting trade or retailers. Consumer promotion may include: price discounts, coupons, on-shelf and in-store coupons, point-of-sale advertising, and loyalty programs, (ii) retail trade promotion may include: price allowances to encourage retailer increased purchasing of a particular product, volume discounts, point-of-sale advertising, and the purchasing of marketing services supplied by the retailer such as advertising in circulars and putting up or installing marketers' promotional materials. Trade promotion expenditures can represent a very significant cost, and, as a result, many marketers choose to compensate retailers with a barter-type transaction of their goods, therefore lessening the economic impact of such transactions. The ability to barter is a significant element of the trade promotion system, and many retailers rely on trade promotion expenditures for a significant portion of their profit. Both types of sales promotion are considered “below the line,” which includes all promotional activities which are not “above the line.” Above the line is defined as media promotion (e.g.,: TV, radio, newspapers, magazines, Internet advertising) in which the advertiser pays an advertising agency to place the advertisements.

Increasingly, marketers and advertising agencies have come to recognize that a significant mass audience resides at retail. For example, a 2003 study by Simmons Research Bureau found that during a given four week period the number of people who visited one of the top 10 retailers was larger than the number who watched all the major broadcast networks (ABC, NBC and CBS) during the same period. Since the late 1980s, there have been many unsuccessful attempts to establish a retail media platform that meets the requirements to be considered planned media.

Many business establishments have installed electronic displays, such as televisions or large format monitors, which enable an electronic image or video display of promotional advertisements and/or content. While the electronic displays have improved efficiency to a certain extent, improvement in revenue generation for the business establishment has been minimal or none for several reasons. First, the number of electronic displays deployed in a retail location is limited therefore resulting in an inability for all of the shopping audience to see the displays. Second, because of the excessive cost of having a staff maintain expensive display equipment, which is generally run off of a local server, cable, or satellite receiver, the electronic displays and associated equipment are often owned and managed by a third party who sells ads to generate revenue and shares only a small portion with the business establishment. Third, because of the limited upside revenue potential in the existing business model in using the electronic displays, the business establishments are not motivated to further expand store populations of electronic displays. Fourth, due to the way this advertising is currently sold, these signs are generally sold as sign or billboard space, which limits the revenue potential to relatively small advertising budgets, rather than attracting media planning revenue from television advertising budgets. Fifth, this process is disruptive to the business establishment's promotional revenue stream as the third party advertisement sales entity targets sales promotion expenditures as it cannot attract planned media dollars therefore reducing revenue previously paid to the retailer.

A number of solutions to provide in-store electronic display media or in-store media systems, often known as digital signage, have been and are still being attempted by a number of companies. Such systems have included the use of large televisions and large plasma or LCD displays, generally being 25-inches or larger (“large format displays”), and positioned at various locations within retail stores. For example, large format displays have been hung from ceilings sporadically throughout a retail store (e.g., in a limited number of aisles, such as 6 or 10, throughout a store), at specialty counters (e.g., deli counter), or at checkout cash register stations. Commercialization using these display placement tactics has failed or had limited profitability due to not capturing sufficient or provable audience “reach” and not providing believable frequency of advertisement view “frequency,” such that advertisers and/or advertising agencies do not consider existing in-store media system configurations to be anything more than a sign or billboard at best and, as such, not a plannable medium as is traditional in-home television.

The three in-store media systems described above are deployed today in various retail store chains. Each of these in-store media systems is limited from a financial point-of-view for the companies deploying or managing the in-store media systems, the retailers, and the advertisers. In the case of the large format displays being positioned sporadically throughout a retail store, not every shopper walks down every aisle and, given the vast sizes of retail stores these days, it is inconceivable that each shopper views one or more displays and has an opportunity to view each advertisement multiple times. Today, retail stores commonly have 200,000 square feet of shopping space, which is roughly the size of four football fields. Having twelve displays deployed in such a large area cannot possibly result in them being viewed by each customer. Even if a customer does have the opportunity to view one or more of the displays, the customer cannot spend enough time in front of the displays to view each advertisement in an advertising “wheel,” which defines a set of advertisements that are repeated over a certain time period.

From a financial perspective, (i) high equipment and technology deployment costs and (ii) limited revenue potential hinder the above described in-store media systems. To fully grasp the magnitude of the costs associated with deploying large screen electronic displays in retail stores of any magnitude, consider that today it costs roughly $7,500 to deploy a single large (e.g., 42-inch) plasma display. Although the plasma screen itself may only cost $1,500, the full costs of deployment, including mounting hardware, power distribution, communications systems, software, installation fees, maintenance fees, management fees, and so forth, increases the cost another $6,000 per electronic display. Now consider a hypothetical grocery store chain with 2,000 stores. Deploying just ten plasma screens per store will cost $150 million across the chain. Considering that modern grocery store sizes range from 48,000 to 60,000 square feet, with 15 to 25 aisles plus perimeter and other shopping areas, ten plasma displays are insufficient to insure that every shopper will view the displays, therefore, considerably limiting the systems audience reach. Limited reach reduces the potential revenue opportunity to the point that neither the retailer nor a third-party in-store media management company could rationalize such expense, as the internal rate of return (IRR) from a pure financial perspective would be quite unappetizing. Furthermore, hanging so many large displays would negatively affect the character of the store, and, therefore, would not be desirable by the retail store management.

The same reach problem exists for positioning the large format displays at a specialty counter (e.g., deli-counter), as each shopper may not shop at that counter or even pass by the counter. While the cost may be affordable at $7,500 per store, the potential reach is limited to those customers who stop at the deli counter and, therefore, quite small. This limited reach would not be valuable from a media planning perspective. There would also be no way to determine frequency of view in such a deployment. Additionally, there is little incentive for an advertiser to promote on a display which could be hundreds of feet away from where that advertisers product is located within the store.

In the case of the displays being located at checkout cash register stations, reach may be obtained, but frequency of view may only be obtained during busy shopping times when traffic at the checkout counters occurs. Furthermore, the reach of the electronic displays at the checkout cash register stations is irrelevant to the retailer and marketers with goods in the store because advertising messages are delivered after shoppers have already completed their selection of goods. In other words, there is little, if any, affect by advertisements displayed on the checkout displays to influence shoppers in their purchases during a shopping trip and, as such, advertisers are unwilling to pay traditional or premium rates for this advertising media.

With regard to the willingness of advertisers paying for advertising on in-store display systems, actual revenues of failed businesses or existing companies in the digital signage field have shown that mass audiences cannot be delivered using conventional deployment schemes. Even though it is well known that retailer-based audiences can be larger than television audiences due to fragmentation of the television market, advertisers have been unwilling to pay even a small fraction of the rates that are paid to television networks even though it is now conventional wisdom that traditional television networks have audience delivery problems. Furthermore, as well known, in-home television advertising does not influence consumers at the time that purchasing decisions are made (i.e., in the store). One reason for the limited acceptance of existing in-store media systems, and the limited revenue they generate, is that advertisers and agency media planners know that these in-store media systems do not deliver reach or frequency of view to a mass audience (i.e., the shoppers) in a method that is understandable to media buyers or planners. In other words, heretofore, advertisers have not considered in-store display networks to be able to deliver a bona fide reach and frequency of view consistent with traditional in-home television for planning or buying purposes.

As evidence that in-store electronic display networks are currently not considered to be a planned medium like television, the top four television networks, American Broadcast Company (ABC®), Columbia Broadcast System (CBS®) National Broadcast Company (NBC®), and FOX each range in ad revenue between $4.5 billion and $11.5B annually. Contrast those ad revenue figures with the largest in-store media system provider with claimed audiences of approximately 150 million viewers per week and 5^{th} largest broadcast network positioning, Premier Retail Network div. Thomson Electronics, with advertising revenues of a mere $100± million annually in 2006. If the audiences are of similar size, one would expect that the revenues would be the same or slightly different. However, the largest in-store media system network provider produces only a small fraction of the revenue of any of the television networks (i.e., $100 million versus a minimum of $4.5 billion). The underpinning reason for such a revenue discrepancy is that media metrics, including reach and frequency of view, cannot be delivered by in-store media system configurations previously or currently deployed in the retail stores and, therefore, agency media planners are unwilling to include such media in a media plan and advertisers are unwilling to pay for such limited advertising at the same level as television advertising.

### SUMMARY

To overcome the inability for in-store media networks to capture mass audience reach and accurately predict frequency of view of advertisements by shoppers, the principles of the present invention provide for a set of mathematical algorithms to determine size, placement and spacing of electronic displays of an in-store display network to establish media metrics, including audience reach and frequency of view, that correlate with or are quantifiably the same or similar as traditional television network media metrics.

By configuring an in-store media network that has the same or similar quantifiable media metrics as traditional television network media metrics, advertisers and agencies are willing to consider the in-store media network as the same or analogous to traditional media and pay advertising rates that are commensurate with traditional television advertising rates. Depending on demand for advertising space for the in-store display network, advertising rates may be lower or higher than advertising rates on traditional television media. In one embodiment, an in-store media network may utilize electronic displays that are small (e.g., 6-12 inches) and affordable, and are powered using an electrical power system that enables easy and cost-effective installation with adjustable placement in a store relative to products being displayed for customers to purchase. Algorithms to meet the desired reach govern the size, quantity, and location of the screens and frequency of view requirements and other media metrics described. The same power system provides for additional screens that can be located close to or in front of specific products being promoted for purchase and subsequently relocated in front of different products as part of the retailers existing sales promotion activities. The media metrics provided through the use of small and affordable electronic displays may be able to provide media metrics more effectively than large format electronic displays and provide a more economical solution than large format electronic displays for in-store display network providers, retailers, and advertisers.

Furthermore, while traditional television networks have been unwilling to participate in the in-store media networks, since the principles of the present invention provide for traditional television media metrics, traditional television networks may now participate in in-store media networks by providing their advertisers and agencies, an alternative and/or combined option for advertising on one or both of the television and in-store media networks. Because the media metrics for traditional television and in-store media networks may be the same or similar, an in-store media network having the same or similar media metrics as traditional television may be considered in-store or out-of-home television.

One embodiment for manufacturing or establishing an electronic display network in a retail store for presenting advertisements to customers may include interspersing electronic displays among product displays in the retail store, and arranging the electronic displays to present a shopper during a shopping trip in the retail store with each advertisement among multiple repeating advertisements displayed on the electronic displays located throughout the retail store a predicted number of multiple times (frequency of view). The electronic displays may be arranged as a function of shopper metrics of the retail store and size of the electronic displays. In addition, the electronic displays may be arranged as a function of desired frequency of view. A spacing distance between each of the electronic displays may be determined to ensure that the shopper has the opportunity to view an electronic display for a predicted duration of time and view each advertisement a predicted number of times while shopping. Because of the configuration of the electronic display network and shopper metrics, a gross rating point media metric may be determined.

One embodiment of an electronic display network may include multiple electronic displays interspersed among product displays in a retail store, the electronic displays being arranged to present a shopper an advertisement from among multiple repeating advertisements displayed on the electronic displays a predicted number of multiple times. A computing system may be in communication with each of the electronic displays, and be configured to communicate the advertisements to the electronic displays. Successive electronic displays may be separated by a distance D that is a function of viewing distance of the successive electronic displays.

One embodiment of a process for selling airtime may include managing or operating an electronic display network operating in a retail store. The network may include electronic displays interspersed among product displays and arranged to present a shopper with each advertisement among multiple repeating advertisements a predicted number of multiple times, or views, as a function of shopper metrics and configuration of the electronic display network during a shopping trip in the retail store. Airtime may be sold to an advertiser or it's agency for an advertisement to be displayed on the electronic display network.

One embodiment of a system for selling television airtime may include a traditional television media metrics management module configured to manage media metrics of a traditional television network. An out-of-home television media metrics management module may be configured to manage media metrics of an out-of-home television network, at least one media metric of the traditional television network matches a media metric of the out-of-home television network. A packaged television media metrics display module may be configured to display the media metric(s) for the traditional and out-of-home television networks for a potential purchaser of airtime to view. An advertisement calculation distribution module may be configured to receive selected airtime purchase parameters and compute a price for the selected airtime. A television advertisement purchase module may be configured to receive and book airtime purchases on the traditional and out-of-home television networks.

Another process for selling airtime for advertising may include establishing a first price for airtime to broadcast advertisements on a first television network on which television programs are played, where the first television network may be a predominantly in-home television network. A second price may be established for airtime to broadcast advertisements on a second television network, where the second television network may be a predominantly out-of-home television network. The first and second prices may be packaged for and presented to potential advertisers to purchase airtime over the first and second television networks. The airtime may be sold to an advertiser to broadcast an advertisement over the first and second television networks.

Another process for selling television media airtime may include establishing media metrics provided by a traditional television network. Media metrics provided by an in-store television network may also be established, where the media metrics for the traditional television network and in-store television network may include at least one of the same parameters. The media metrics of the traditional and in-store television networks may be packaged and presented to a potential advertiser.

One embodiment of a retail store may include product displays located throughout a floor, indoors and/or outdoors, where the product displays have products available for purchase by shoppers. An in-store television network may include multiple electronic displays interspersed throughout the product displays. The in-store television network may have predictable media metrics that are substantially the same as a traditional television network. In being substantially the same, the media metrics may include predictable audience reach and frequency of view of advertisements in an advertising wheel to enable advertisers to interpret the media metrics in the same or similar manner as performed for traditional television networks.

### BRIEF DESCRIPTION OF THE DRAWINGS

For a more complete understanding of the present invention, reference is made to the following detailed description taken in conjunction with the accompanying drawings wherein:

FIG. 1 is a block diagram showing an exemplary affiliation of a media network company (i) with a service provider or (ii) directly with business establishments;

FIG. 2 is a block diagram showing an exemplary affiliation of a network service provider/media network company having a affiliation with business establishments and an advertising agency and media planning company and a promotional in-store media planning service company;

FIG. 3 is an exemplary illustration of a fixture operable to display products and support electronic displays that may be operated by the business establishments of FIGS. 1 and 2;

FIG. 4 is a block diagram of an exemplary system for managing, distributing, and displaying content at business establishments;

FIG. 5 is an exemplary graphical user interface for a user to book or purchase airtime for content to be displayed at the business establishments;

FIG. 6 is a flow chart that provides an exemplary process for managing a partitioned network according to the principles of the present invention;

FIG. 7 is a flow diagram descrbing an exemplary process for partitioning airtime between a network service provider and/or a media network and business establishment;

FIG. 8A is an illustration of an exemplary shopping venue having an aisle in which electronic displays may be positioned;

FIG. 8B is a flow diagram of an illustrative process for establishing an out-of-home television network;

FIG. 8C is a flow diagram of a more detailed illustrative process for establishing an out-of-home television network;

FIG. 9A is a block diagram of traditional and out-of-home television networks;

FIG. 9B is a block diagram depicting illustrative modules for collecting and presenting media metrics on traditional and out-of-home television networks;

FIG. 9C is a screen shot of an illustrative graphical user interface for a purchaser of airtime to view media metrics on traditional television and out-of-home television networks, select airtime, price the airtime, and upload an advertisement;

FIG. 10 is a block diagram depicting exemplary modules for enabling an out-of-home electronic display network to be configured to provide predictable media metrics;

FIG. 11 is a flow diagram describing a process for selling airtime;

FIG. 12 is a flow diagram of an exemplary process for selling airtime for advertising; and

FIG. 13 is a flow diagram of an exemplary process for selling television media airtime.

### DETAILED DESCRIPTION

A traditional media or broadcast television network is formed of a national headquarters and local network (also referred to as local or broadcast affiliate), which may or may not be owned by the media network, to distribute programming over the air in order to attract an audience. The media networks may be established to broadcast content, as defined below, over one or more media or technical networks, including television, cable, satellite, radio, Internet, etc. In the case of television, the media network sets aside predetermined amounts of airtime (called avails) that are sold to third party advertisers or their agencies wishing to advertise their products or services to the audience delivered by the content. Programming may include shows, movies, sporting events, concerts, news, commentary, etc. In general, an advertisement is defined as a notice designed to attract public attention or patronage. For the purposes of this application, content is programming and/or advertisements, where advertisements may include messages. Examples of traditional television networks are ABC®, NBC®, CBS®, and FOX®. The main network difference between a broadcast and a cable network is that the local cable system operator replaces the local network or broadcast affiliate, as the content distributor to the audience. Examples of cable networks are CNN®, USA®, TNT®, and The Discovery Channel®.

A network service provider is a company that provides services to a physical network or infrastructure that delivers signals to endpoints on the network to deliver content and other services. For example, an internet service provider (ISP) is a company that provides access to the Internet for companies and individuals. Additionally, a cable service provider that provides cable services to homes is an example of a network service provider. In each of these and other technology cases, the network service provider performs the technical aspects of providing infrastructure, including distributing set top boxes, performing installations, performing wiring operations, and managing and distributing content to the subscribers, etc.

A broadcast media network is generally a television or radio network formed of a national headquarters and local network affiliates, which may or may not be owned by the media network, to distribute content over a broadcast network infrastructure. Cable networks are formed of a headquarters and local cable operators and/or cable companies, which may or may not be owned by the cable network. A satellite network replaces the cable company and communicates wirelessly with customers or subscribers. When television network programming results in larger, and possibly more targeted audiences, marketers may be willing to pay higher costs for advertising airtime as more viewers are watching the programming and, therefore, may watch the advertisements and potentially purchase or participate in goods and services provided by the advertisers.

Broadcast networks traditionally allocate 60 percent of the available advertising airtime across the entire network to the national headquarters, commonly understood in the art as “national avails,” and local affiliates retain the remaining 40 percent of the available advertising airtime within their local market, commonly understood in the art as “local avails,” thereby creating a partitioned network structure around content provided by the media networks. For example, a typical one hour program today tuns for 42 minutes. Of the remaining 18 minutes, 11 minutes are national avails and 7 minutes are local avails. Cable networks follow a similar partition structure with cable operators (the local affiliate). However, it should be understood that other ratios may be similarly used and/or negotiated.

The principles of the present invention may utilize the systems and methods provided in co-pending U.S. patent application Ser. No. 11/600,498, which is herein incorporated by reference in its entirety, which describes a communications system operable to manage and distribute content to electronic displays that are operated at business establishments, such as retail stores. A communications system that distributes the content to electronic displays via a local server or directly thereto may be utilized by the principles of the present invention.

A business establishment may form a business relationship with a media network, network manager/service provider and/or directly with any network so that content, which may or may not be associated with products sold at the business establishment, may be displayed on the electronic displays or other visual device. The business relationship between a traditional broadcast television network its local affiliates may be used as a model, whereby the local network affiliate replaced by a business establishment or retailer. Consider for example, that a retail chain, such as Food Lion®, is a local affiliate operating individual store locations that may control content being displayed at each store and on each electronic display, in one embodiment. The retail chain is a network of related business establishments.

The retail chain acting as a local affiliate can itself become part of a larger network of local affiliates formed of multiple, non-related business establishments (i.e., a network formed of different retail chains) that, in essence, results in a national network that provides a mass viewing audience exactly where marketers desire to display their messages—at the point-of-purchase, where most consumer buying decisions occur. By forming this national network of multiple, non-related business establishments, advertisers and their agencies are able to advertise to a large viewing audience by purchasing national avails or local avails in a fashion compatible with traditional media planning practices. Enabling reach to an audience that is able to make instant purchasing decisions if the product or service is available at that business establishment ensures a marketer an opportunity to have its product purchased by each member of the audience (i.e., the shoppers).

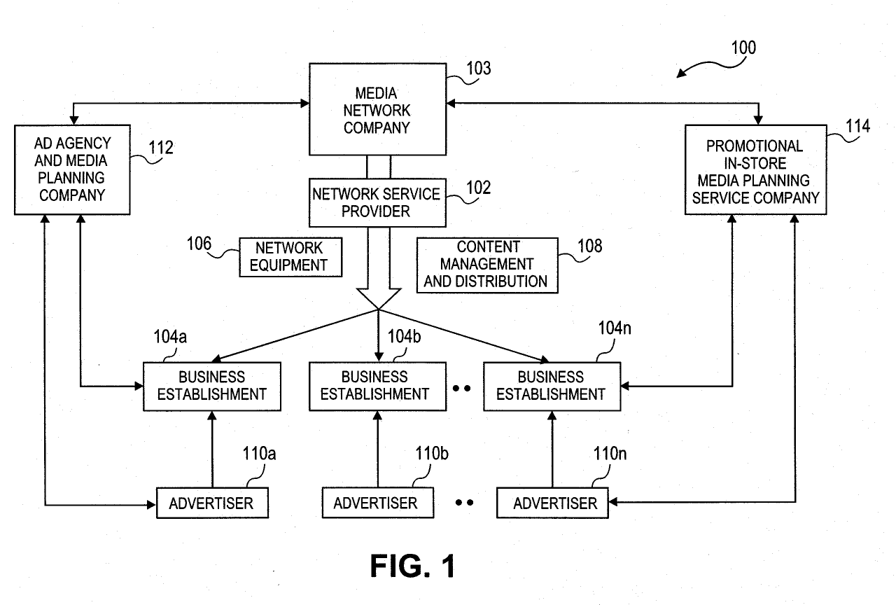

FIG. 1 is an exemplary block diagram 100 showing a network service provider 102, media network company 103, and affiliated business establishments 104a-104n (collectively 104). The media network company 103 may utilize infrastructure established by or in conjunction with the network service provider 102 and operated by the business establishments 104 or any other third party.

The media network company 103 may be a traditional broadcast company, such as NBC®, or a traditional cable network company, such as CNN®. The business relationship may have the Aetwork service provider 102, media network company 103, the business establishment itself or other third party provide the business establishments 104 with network equipment 106, and/or content management and distribution services 108. The network equipment 106, which operates in conjunction with a communications network (e.g., broadcast television and radio, satellite, cable, cellular, Internet, wide area networks, etc.), may include communication equipment, such as a satellite dish, server, local Ethernet, and electronic display devices (e.g., CRT, LED, OLED, LCD, plasma, etc.), which may communicate with the local server via the local Ethernet or be directly accessible via the communications network.

The business establishments 104 may thereby provide advertising services (i.e., sell airtime), directly or indirectly through third parties, such as an ad agency and/or media planning company 112 (“ad agency”) and/or promotional in-store media planning service company 114 (“promotional service company”), for advertisers 110a-110b (collectively 110). While the ad agency 112 and promotional service company 114 perform similar services, each is generally paid from different budgets from the advertiser 110, the advertising budget pays for the work of the ad agency 112 and the promotional budget pays for the work of the promotional service company 114.

The configuration of the business relationships allows the business establishments 104 to generate airtime revenue and potentially increase sales of products and services. In one embodiment, the business establishments 104 do not obtain the network equipment 106 via a capital expense, but rather pay a monthly service fee. Such a financial arrangement allows the business establishments 104 to treat the network equipment as an expense, which further financially helps the business establishments 104 or the business establishment receives equipment in exchange for delivering its audience to the media network company 103.

A partitioned network model may be established between the media network company 103, service provider 102, business establishments 104 and/or any other third party. The partitioned network model creates both national airtime spanning multiple, non-related business establishments 104 and local airtime belonging to one or more related business establishments 104a (e.g., a single retail chain store, such as Food Lion®). By establishing a partitioned network model for sharing airtime for display of content on at least a portion of the electronic displays, the business establishments are provided with a financial incentive to acquire and utilize the network equipment. The partitioned network model is represented in FIG. 1 by having the ad agency 112 and/or the promotional service company 114 or any third party agent buy and sell or otherwise transact airtime for the advertiser 110 to display content on at least a portion of the electronic displays at the business establishments 104, thereby providing the media network company 103 and business establishments 104 with an airtime revenue base from national, regional, and local airtime sales. The airtime revenue base may be derived by apportioning airtime booking and/or display revenues between the media network company 103 and business establishment 104.

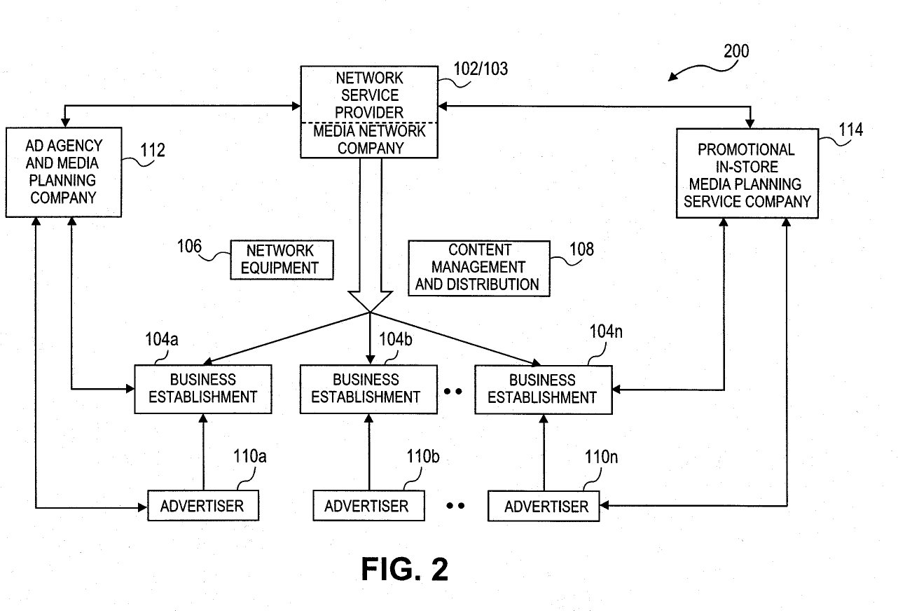

FIG. 2 is a block diagram showing an exemplary network model similar to that of FIG. 1, but the media network company 103 has been integrated with the network service provider 102. In one embodiment, the network service provider/media network company 102/103 is capable of providing national airtime on its affiliate network with the business establishments 104. In another embodiment, the network service provider/media network company 102/103 may provide network services as does a network service provider and itself become a network service provider that is capable of providing national airtime on its affiliate network with the business establishments 104.

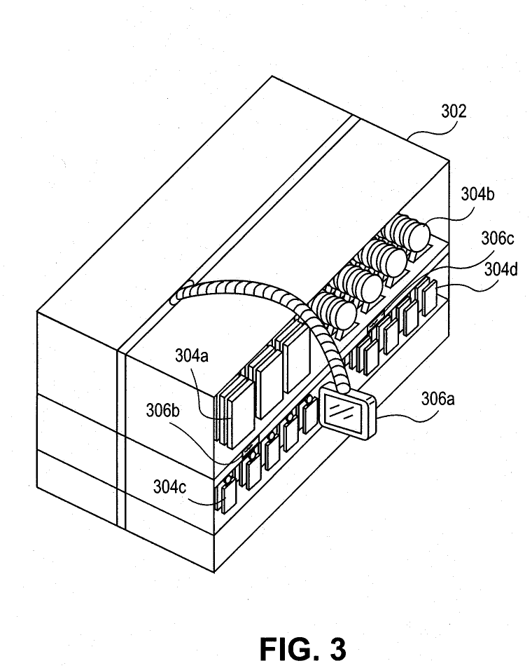

FIG. 3 is an exemplary illustration 300 of a fixture 302 operable to display products 304a-304d (collectively 304) and support electronic displays 306a-306c (collectively 306), which may operate in accordance with the description of the visual appliances as described in co-pending U.S. patent application Ser. No. 11/600,498 and configurations of hardware for mounting the visual appliances or electronic display devices to structures that support products (e.g., gondolas and shelves) or are otherwise part of the physical structure of a building (e.g., walls and poles) as described in co-pending U.S. patent application Ser. No. 11/600,635, which is herein incorporated by reference in its entirety. The electronic display 306a may extend from the top of the fixture 302 into the line of sight of customers and may serve to display content and promotional messages. While the electronic displays 306b-306c may be mounted to the shelf-edges and may serve to display more targeted messages (e.g., promotional advertisements for products 304), other locations may be utilized for electronic displays 306 to operate in shopper field-of-view or line-of-sight locations including, but not limited to, walls, ceilings, poles, etc. Additionally, other location configurations and types of electronic displays 306 may be utilized by the business establishments 104 in accordance with the principles of the present invention.

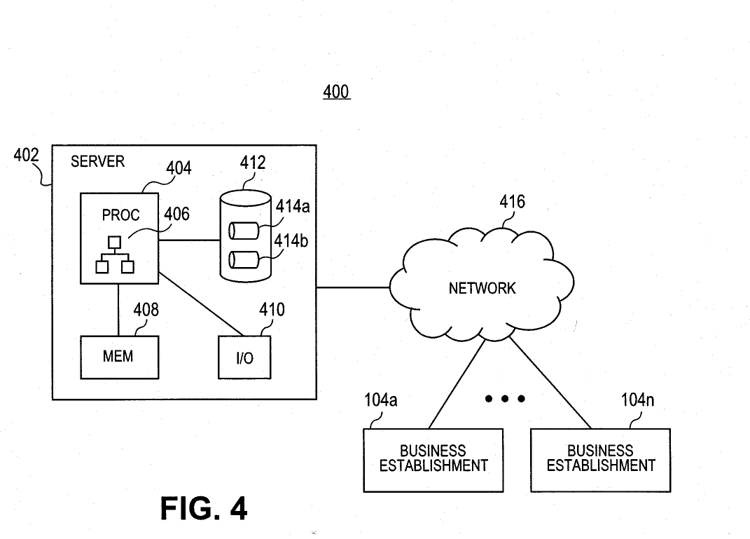

FIG. 4 is a block diagram of an exemplary system 400 for managing, distributing, and displaying content at business establishments. The system 400 includes a server 402 that includes a processor 404 operable to execute software 406 that performs a variety of functions to manage content to be displayed at the business establishments. The server 402 further includes a memory 408 for storing the software 406 during execution and data associated with the content. An input/output (I/O) unit 410 is also included for communicating information related to the content. A storage unit 412, such as a disk drive or other mass storage unit, includes one or more databases 414a-414b (collectively 414) or other data repository. It should be understood that the storage unit 412 may be included as part of the server 402 or in communication with the server 402 and remotely located from the server 402. The databases 414 may be utilized to store information generated by the software 406, such as playlists that are utilized to book or schedule airtime for content to be distributed and displayed on the electronic displays located in the business establishments 104.

The server 402 may be in communication with a network 416, such as the Internet, for enabling users to remotely interact with the software 406. The users may be employees of the business establishments 104 or agents thereof Alternatively, employees or agents of a network service provider 102 (FIG. 1 or 2), media network company 103 (FIG. 1 or 2), ad agency 112 (FIG. 1 or 2) and/or promotional service company 114 (FIG. 1 or 2) may interact with the software 406 to book or purchase airtime for content to be distributed to and displayed at the business establishments 104. The business establishments 104 may include servers (not shown), the same or similar to the server 402, that are configured to receive one or more playlists and content from the server 402. The servers at the business establishments 104 may be configured to store and communicate the playlist(s) and video content to electronic displays to which the content is assigned to be played.

In operation, the software 406 may be used to generate one or more playlists that are used for booking airtime for content to be displayed in the business establishments 104. TABLES I and II are illustrative playlists that may be generated and managed by the software 406 for a user to national airtime and/or local airtime, respectively.

TABLE I
National Content

| AD | LOC | Run-time | LENGTH |
|---|---|---|---|
| A | NAT'L | M-F | 0:06 s |
| B | NAT'L | M-F | 0:06 s |
| C | NAT'L | M-F | 0:06 s |
| D | NAT'L | M-F | 0:06 s |
| E | NAT'L | M-F | 0:06 s |
| F | NAT'L | M-F | 0:06 s |

TABLE II
Local Content

| AD | LOC | Run-time | LENGTH |
|---|---|---|---|
| G | BE 1 | M-F | 0:06 s |
| H | BE 1 | M-F | 0:06 s |
| I | BE 1 | M-F | 0:06 s |
| J | BE 1 | M-F | 0:06 s |

The playlists shown in TABLES I and II may be formed and stored in the memory 408 and/or storage unit 412 by the software 406 utilizing programming techniques as understood in the art. TABLE I represents a first series of memory locations or records that identify the content (e.g., A-F), locations for the content to be displayed (e.g., nat'l, business establishment (BE) 1), runtime for the content or advertisements to be displayed (e.g., M-F), and length of the content (e.g., six seconds). Because each content segment is six seconds, a one-minute airtime playlist may include ten different content segments, where a content segment is considered a complete piece of content. The software 406 may further be utilized to distribute the content identified in the TABLES prior to the time booked for display at the respective business establishments 104. TABLES I and II may include additional information, such as network addresses of electronic displays located in the business establishments 104. In one embodiment, the playlists distributed to the electronic displays in a business establishment are synchronized so that each electronic displays display the same advertisements at the same time (i.e., each of the electronic displays are synchronized), thereby ensuring that each shopper is provided the opportunity to view each advertisement a predicted number of multiple times.

The software 406 may further automatically adjust the playlists or programming wheel, generally known in the art as “the wheel,” based on the number of contents segments to be booked during a given time period. The wheel describes how often content is displayed to provide maximum consumer viewing. For example, if a national booking is only filled to 50 percent capacity, then the wheel may be automatically expanded to add timeslots for additional content to be displayed on a local level. Similarly, because the system according to the principles of the present invention may operate on a substantially real-time basis, if additional content is scheduled while a wheel is not completely filled, new content may be insetted into the wheel and distributed to the associated business establishments. The wheel may also be shortened or contracted by removing content or simply not including the content in the first place, thereby increasing the number of times or frequency that the wheel is displayed per hour. It should be understood that the wheel may be increased or decreased at a central location or locally while being operated at distributed locations (e.g., business establishment). Although the length of the content are shown to be the same (e.g., 6 seconds), an advertiser may purchase two or more timeslots and provide content that is a multiple of 6 seconds (e.g., 12 seconds). Content with non-uniform or non-multiple lengths may be utilized, as well.

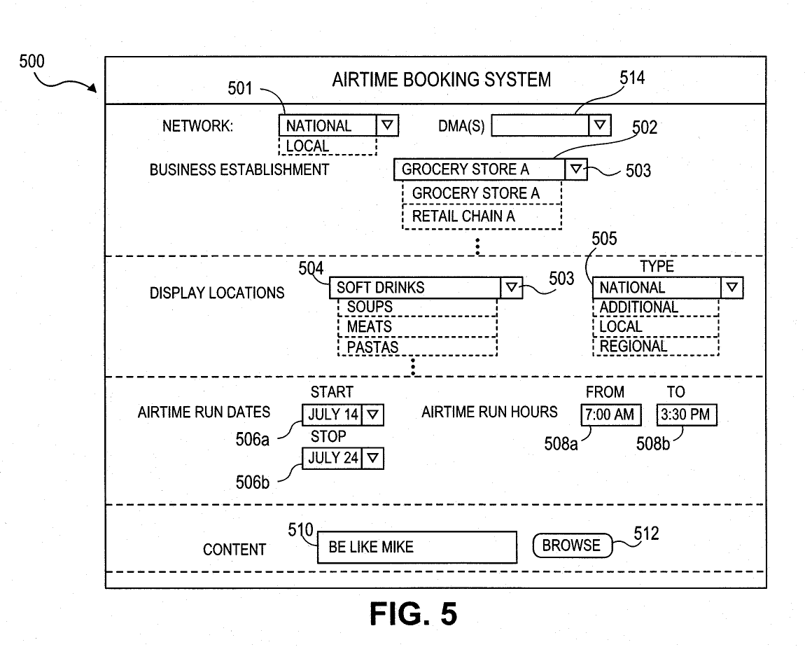

FIG. 5 is an exemplary graphical user interface (GUI) 500 for a user to book airtime for content to be displayed at the business establishments 104. The GUI 500 may be accessed via the Internet and displayed in a web-format or executed locally on an internal network. The GUI 500 may include a number of parameters for a user to enter for booking airtime for content to be displayed at a business establishment 104. A user may be an employee or agent for any of the participants shown in FIGS. 1 and 2.

Eight parameters are shown in the GUI 500, including “network,” “business establishment,” “display locations,” “type of delivery,” “airtime run dates,” “airtime run hours,” “content,” and “DMA(s).”

The “network” parameter may enable a user to select whether an advertisement is to be displayed on a national network, which would be across multiple retail chains, or local network, which would be across a single retail chain.

Associated with the “business establishment” parameter is a data entry field 502 that includes a drop-down menu button 503 for displaying predetermined potential business establishments (e.g., “Grocery Store A,” “Retail Chain A,” etc.) available for selection, which may contain various shopping and viewing data. Alternatively, the user may type the name of the business establishment or utilize another input technique to identify the business establishment or establishments in which to book airtime for displaying content. In this case, the user selected “Grocery Store A,” which is written in the entry field 502 as an identifier associated with a particular grocery store company. It should be understood that rather than using particular names of the business establishments 104 that codes or other identifiers may be utilized for selection of the particular business establishments.

The “display locations” parameter represents the location of the electronic displays that any of the participants of FIGS. 1 and 2 or any other user wishes to display content. The “display locations” parameter is typically available for local network display of content on a shelf-edge electronic display. For example, display locations may include “soups,” “meats,” “pastas,” etc., that represent sections or aisles in which the electronic displays 306 (FIG. 3) are located. For example, an advertiser who makes and sells soft drinks (e.g., Coca-Cola®) may advertise on one of the shelf-edge displays 306c located in the soft drink section. Alternatively, another manufacturer, such as a maker of snacks, may wish to cross-advertise or promote in the soft drink section to remind purchasers of soft drinks to purchase snacks. In either case, an entry field 504 may receive a “soft drinks” entry, thereby indicating that the advertiser wishes to display the content on an electronic display located in the soft drinks section or aisle of a store. In an alternative embodiment, rather than specifying the generic term for the section or aisle, the GUI 500 may use identifiers or name brands identified on a planogram (i.e., schematic drawings of fixtures that illustrate product placement within a business establishment) to enable the user to particularly select electronic displays 104 located at particular locations within the business establishments 104 to display the content.

A “content type” section enables a user to specify the type of content that the user wishes to run. The options shown include “national,” “local,” or “regional” and the user may enter the selection in the entry field 505. A selection of “national” will cause the content to be displayed in multiple, unrelated business establishments across the country, “regional” will cause the content to be displayed in multiple, unrelated business establishments in a local region (e.g., New England), and “local” will cause the content to be displayed in one or more related business establishments (e.g., Food Lion®). Other regions or selections may be provided for a user to specify the locations in which to display the content. For example, types of stores (e.g., “drug stores”), traffic requirements (e.g., stores with 10,000 shoppers or more per day), etc., and certain other third party data (e.g., Nielsen data, designated market area (DMA), In-Store Research Institute (IRI) data, U.S. census data, etc.) may be provided as selections for a user to select the location in which to display the content.

The GUI 500 further includes an “airtime run dates” section that enables a user to select dates to book airtime for content to be displayed. As shown, two entry fields 506a and 506b, “start” and “stop,” enable a user to enter starting and stopping dates. Alternatively, other entry fields or indicators may be utilized to enable a user to enter dates for the content to run. For example, week, month, or year may be utilized to indicate to a user when to run the content. Additionally, “airtime run hours” may be selected in entry fields 508a and 508b so that more targeted content display may occur for advertising or promoting a product. For example, a baby food manufacturer may wish to run content during the times that mothers are shopping, such as 7:00 AM to 3:00 PM. In one embodiment, a calendar may be presented to the user to drag and drop content or otherwise apply selected content in available airtime.

The GUI 500 further includes a “content” section in which the user is able to identify the content that is to be displayed at the selected airtime run dates. An entry field 510 may be utilized to enter the name or other identifier of the content. A browse soft-button 512 may be included that may be selected to enable a user to browse for the name or identifier of the content on a storage medium, such as a local or remote disk drive.

The “DMA” parameter 514 enables the user to select particular DMA(s) in which to play the selected advertisement. As understood in the art, the DMA or designated marketing area, may be those established by the Nielsen Company. While shown as a pull-down menu, the DMA selection may be presented in many other forms, such as a hierarchical selection tool, map, or any other graphical user interface element that enables the user to select particular geographical areas in which to play an advertisement in a retail store.

The GUI 500 provided is very basic and it should be understood that more sections and tools may be provided for a user to book airtime for content to be displayed on electronic devices 306 at business establishments 104 (FIG. 1). The number of combinations is almost limitless in terms of options and parameters for specifying how, when, where, and for what price to display content within business establishments 104. Further, one or more GUIs may be utilized to enable a user to book airtime for content to be distributed along the national or local channels provided by the affiliated network described in FIGS. 1 and 2. In other words, marketers (e.g., advertisers) or their agents who wish to book airtime on a national or regional level in multiple stores may utilize one GUI and marketers or their agents who wish to book airtime locally with a particular business establishment 104a may utilize a second GUI. The system may utilize passwords or other security measures to enable marketers or their authorized agents to access the airtime booking system.

Continuing with FIG. 3, two networks of electronic displays are shown, a first network including the shelf-edge electronic displays 306b and 306c and a second network including the overhead or line-of-sight electronic displays 306a. The shelf-edge electronic displays may be provided to the business establishment 104 to promote or sell “sign or promotional ad” space to marketers 110 under a subscription, rental fee agreement, or otherwise, as described in co-pending U.S. patent application Set. No. 11/600,498. The line-of-sight electronic displays 306a may be partitioned as broadcast airtime as follows:

1.Local network partition airtime available to the business establishments 104 (i.e., local affiliate) or promotional in-store media planning service company 114 to sell to marketers 110, thereby serving as local airtime or local avail.

2.National network partition airtime available to the media network company 103 or ad agency and media planning company 112 to sell to marketers 110, thereby serving as network airtime or network avail.

The national avails and local avails may be allocated and sub-divided into segments to sell to marketers 110. In one embodiment, the media network company and/or network service provider 102/103 may retain 36 minutes of airtime per hour for the national network partition while 24 minutes of airtime per hour may be allocated to the local affiliate or business establishment 104 for the local network partition, therefore adhering to a standard 60/40 or 3:2 airtime inventory split regardless of frequency of play of content. The airtime revenue associated with the local affiliate's 24 minutes of airtime per hour from electronic displays 306a and the promotional ad space of the shelf-edge electronic displays 306c may be retained by the local affiliate or business establishment 104 through sales to vendors and non-vendor advertisers or however the local affiliate sees fit to maximize the revenue potential of the overhead and shelf-edge visual appliance 306a-306c. If airtime is used for head of the hour news or otherwise, the time consumed for such purposes may be reduced proportionally from both the network service provider 103 and local affiliate 104 (i.e., the national and network partitions are proportionally reduced).

For the business establishments 104, the airtime apportioned thereto or local avail may be booked by the participants of FIGS. 1 and 2 or any other third party or otherwise so that the airtime is simply a revenue generating resource for the business establishments 104. For the network service provider 102 and/or media network company 103, the airtime apportioned thereto or national avail may be sold or auctioned to advertisers 110, ad agencies 112, and/or promotional service companies 114 or others.

The processor 404 of FIG. 4 may execute software to operate an algorithm that may be used to determine programming “wheel” construction. This or another algorithm further may be used to determine the number and placement of overhead and other line of sight electronic displays 306 (FIG. 3) in the business establishments. The variables in the algorithm may include average customer time spent in the business establishment, size and construction or configuration of the business establishment, customer traffic counts within the business establishment, customer flow patterns within the business establishment, customer visitation frequency per period, and a definitive run pattern exposure plan to insure to content providers the maximum advantage of accepted reach and frequency levels, as understood in the art. In one embodiment, a “wheel” or content loop may be five minutes long and include six, ten second content segments per minute so that there are 30 content segments played in that wheel. A shopper of a store who shops for 30 minutes may therefore have the opportunity to see a content segment up to six times. If the wheel is ten minutes long, 60 content segments are available and the shopper has an opportunity to view each ad segment three times. A more detailed algorithm for ensuring that the electronic displays 306 are viewed is described herein below.

The programming wheel may be composed of (i) network, regional/national, and spot avails, and (ii) local affiliate regional/local, and spot avails, in similar fashion to typical broadcast/cable television and radio trafficking procedures. Because the business establishment 104 allows the electronic displays 306 to be operated in their stores, they may control or have a say in the type of content that can be displayed in the stores.

Continuing with FIG. 3, the shelf-edge electronic displays 306b-306c may be placed in close proximity to specific products 304. Because of this close proximity, the shelf-edge electronic displays 306b-306c may promote one product per shelf-edge electronic display and be dynamically optimized for shopping patterns during a given time period. In general, this cycle coincides with the weekly promotional activity of the local affiliate, but may operate by promoting products per cycle or off-cycle.

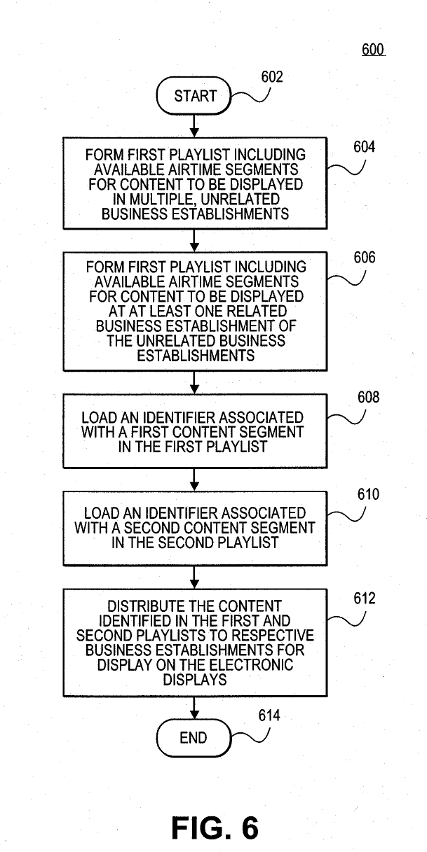

FIG. 6 is a flow chart that provides an exemplary process 600 for managing the partitioned network according to the principles of the present invention. The process 600 may be coded into the software 406 and be executed on the processor 404 of FIG. 4. The process starts at step 602. At step 604, a first playlist is formed that includes available airtime segments for content to be displayed in multiple, unrelated business establishments. The playlist may be formed of a series of memory locations that each form a record. At step 606, a second playlist that includes available airtime segments for content to be displayed at least one related business establishment of the unrelated business establishments may be formed. The at least one business establishment may include one or more stores of a single retail chain or be a member of an association (e.g., independent petroleum providers of an independent petroleum providers association).

At step 608, an identifier associated with one or more first content segments is loaded in the first playlist. At step 610, an identifier associated with one or more second content segment is loaded in the second playlist. The content identified in the first and second playlists to respective establishments for display on the electronic displays is distributed at step 612. The process ends at step 614.

In accordance with the principles of the present invention, the playlists may be the same or different lengths. For example, if the partitioned network is 60 percent national and 40 percent local, then the first playlist may be longer than the second playlist. More specifically, a ratio of the length of the first playlist to the second playlist may be approximately 3:2 (assuming that each time segment is equal). A third playlist may be formed for booking local airtime for content to be displayed in a second business establishment 104b. It should be understood that the playlists may simply be formed as part of a larger playlist and not be specifically located in a separate portions of memory.

There may be several different ways for distributing the content from a system point-of-view. First, the content identified in the playlists, national and local, may be organized at a server and distributed in full and servers and/or electronic displays 104 operating at the business establishments may accept the content identified to be played at the particular business establishments and disregard the content not identified to be played at the particular business establishments. Second, the content identified in the playlists may be individually distributed so that the content identified to be distributed locally or to particular business establishments are only distributed thereto. Third, if ad content identified on a playlist has been previously distributed to the business establishments, but identified to be displayed again, that content is not redistributed to conserve bandwidth.

In booking the airtime, booking information, such as a list of business establishments 104 to display the content, display dates, display times, etc., may be communicated to a user via a network, such as the Internet. The user may be any individual authorized to book airtime for advertisers, media network company and/or business establishment.

In booking the airtime, at least three metrics may be utilized. First, the cost may be based on booking airtime for the content to be displayed over a certain period of time (e.g., between specified dates and times for content to be displayed).

Second, the cost of booking the airtime may be based on displaying the content (i.e., a certain number of displays costs a certain amount of money). To avoid under- or over-delivery of audience situations, the number of showings of the content may be adjusted based on the number of impressions that are made rather than simply a finite number of times the content is to be shown (e.g., $10 per 1000 displays). An impression is the number of times individuals view the content. Because the network equipment provided to business establishments may be tied into the point-of-sale systems or other data collection devices of the business establishments as described in co-pending U.S. patent application Ser. No. 11/600,498, the number of impressions can be accurately determined by polling the point-of-sale system or device and/or collected third party data, such as Nielsen data, thereby using such data to determine the number of viewers or impressions during the time periods that content is being displayed. And, because there is feedback of actual numbers of people passing through the point-of-sale location (e.g., cash register) or other traffic measurement systems during the times of display of the content, the system may automatically avoid under- or over-delivery of impressions on a substantially real-time basis (as opposed to traditional television techniques that rely on the collection of post viewing samples of viewership and reporting techniques that generally occur weeks/months after actual content airing). The system may operate to adjust by increasing or decreasing the duration, in terms of hours or days, frequency of view, or reach that the content is displayed by adjusting the playlist. The playlist may be adjusted centrally or locally.

It should be understood that while the principles of the present invention provide for an automatic adjustment of the duration for playing content on a substantially real-time basis based on feedback from a POS or other system in a business establishment, the principles of the present invention contemplate for a similar system to be based on actual viewership of television or other media if technology for measuring the viewership exists. For example, if set top boxes or satellite systems, for example, provide for feeding back the channel currently being watched by viewers, then the content distribution system may determine actual viewership and adjust the duration of playing content per a contract or other agreement to avoid under- or over-delivery of the content, thereby minimizing contract disputes between advertisers or other airtime purchasers and media network companies.

Third, the cost of booking airtime may be fixed based on a number of views or impressions. For example, an advertiser may pay a certain amount of money for a certain number of views (e.g., $1 per 1000 views up to $1 million). It should be understood that other variations and metrics may be utilized to charge for booking airtime, such as a percentage of the sale of goods or fixed amount based on consumer action (e.g., increased products purchased).

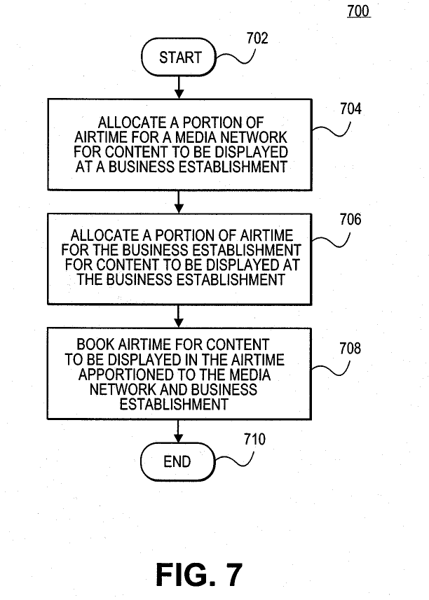

FIG. 7 is a flow diagram describing an exemplary process 700 for partitioning airtime between a media network and business establishment. The process starts at step 702. At step 704, a portion of airtime for the national avail content to be displayed at a business establishment is allocated. At step 706, a portion of airtime for the local avail content to be displayed at the business establishment is allocated. In one embodiment, the allocation of the airtime for the national avail is approximately 60 percent and the allocation of the airtime for the local avail is approximately 40 percent. Airtime for the content to be displayed in the airtime apportioned to the national avail and local avail is booked at step 708. In booking the airtime, any of the participants, advertisers 110, ad agency 204, promotional service company 206, and/or any third party may participate. In addition, the booking of the airtime may be performed via a graphical user interface as described hereinabove. The process ends at step 710.

### Media Metrics

Although traditional television provides entertainment, news, and other information to viewers, the business of television is one of mathematics or media metrics that describe an audience through ratings, reach, frequency of view, and gross rating points, among many other media metrics. Media metrics provide advertisers and their agencies with the ability to plan their gross rating point airtime purchases and, thus, plan their advertising budgets because in order for companies to financially survive through selling their products or services, the advertisers have to reach a certain size audience with a given frequency of view to ensure that members of the audience have an opportunity to view an advertisement a predictable number of times to become consumers of their products or services.

One distinguishing difference between traditional television audiences and audiences or shoppers within a shopping venue (e.g., retail store) is that traditional television audiences are incapable of making an immediate purchase of the product or service, whereas shoppers are able to purchase products or services as they are actively shopping. Another important difference is that traditional television delivery is only an estimate based on a statistical extrapolation while retail-based audiences are factual. The principles of the present invention provide for an in-store display network that may be described with the same or analogous mathematics that describe traditional television networks, thereby enabling airtime purchases to be planned on the in-store display network as part of the traditional media planning process potentially as part of the television budget line.

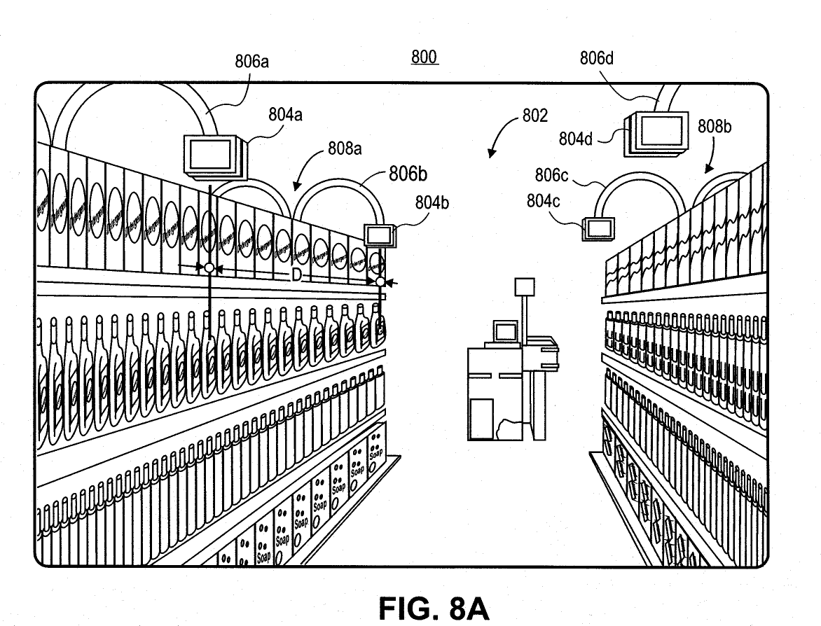

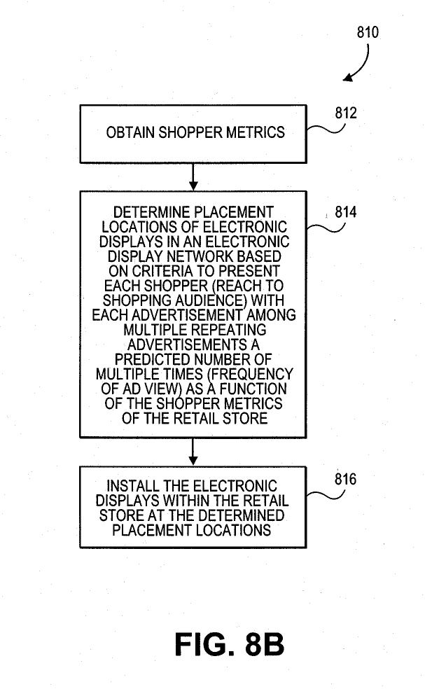

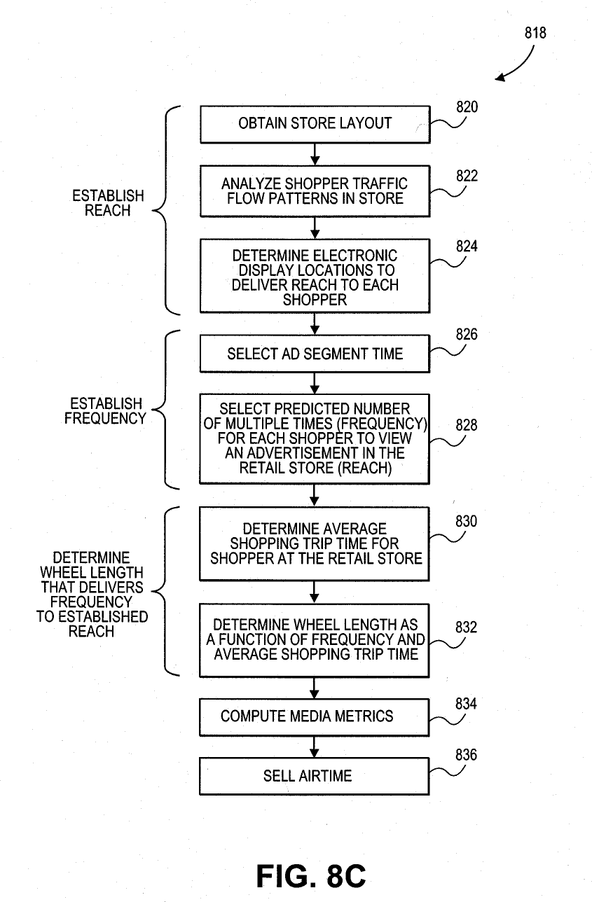

FIG. 8A is an illustration of an exemplary shopping venue 800 having an aisle 802 in which electronic displays 804a-804d (collectively 804) may be positioned. The electronic displays 804 may be positioned along the aisle 802. In one embodiment, the electronic displays 804 are part of an electronic display network, the same or similar to one described in co-pending U.S. patent application Ser. No. 11/600,498. As shown, the electronic displays 804 may extend on arms 806a-806d (collectively 806) respectively, that provide electrical power from respective gondolas 808a and 808b. One embodiment of a power system for providing electrical power to the electronic displays 804 is provided in co-pending U.S. patent application Ser. No. 11/600,635, which is herein incorporated by reference in its entirety. It should be understood that alternative configurations of the electronic displays 804 may be utilized. For example, the electronic displays 804 may be positioned further into the aisle 802, such as being centered along the aisle 802. Alternatively, rather than extending the electronic displays 804 from arms 806, power rails or discrete power outlets may be positioned along the ceiling.

The electronic displays 804 may be positioned within the field-of-view of customers who are shopping. For the purposes of this description, an electronic display being in a shopper's field-of-view is one that a shopper is able to see when walking along a pathway, such as an aisle, of a shopping venue. In one embodiment, a shopper's field-of-view may be considered to be approximately 45 degrees or less from a person's line-of-sight with his or her head being at neutral (i.e., while looking straight ahead). It should be understood that the electronic displays 804 may be positioned within the shopping venue 800 such that a shopper may view an electronic display along substantially every pathway in the shopping venue 800 to ensure that media metrics, such as reach and frequency of view, are predictably delivered, thereby enabling advertisers to plan their advertising audience. To be within the field-of-view of shoppers or customers, the height of the electronic displays 804 may be ten feet or lower, as this height enables an average height shopper to maintain the electronic displays 804 within their field-of-view without having to tilt their heads any significant amount so that viewing the content is not such an effort that shoppers ignore advertisements being displayed thereon.

Continuing with FIG. 8A, the number of electronic displays 804 and spacing or separation distance D between each of the electronic displays 804 along an aisle 802 or other pathway may be dependent on a number of factors. Determining a number of electronic displays and spacing D between each to predict or otherwise predetermine a reach and frequency of view of the shoppers may be described by a mathematical algorithm, as described below.

TABLE III
Shopper Metrics

| | Trip | | | | | | |
|---|---|---|---|---|---|---|---|
| Trip | Time | | | | No. | Total | Trip time |
| Type | (minutes) | % shoppers | Trans/Week | Viewers/Trans | Shoppers | Minutes | weighted avg |
| Fill up | 54 | 13% | 12,500 | 1.28 | 2,080 | 112,320 | |
| Medium | 40 | 25% | 12,500 | 1.28 | 4,000 | 160,00 | |
| Quick | 20 | 62% | 12,500 | 1.28 | 9,920 | 198,400 | |
| Totals | | 100% | | | 16,000 | 470,720 | 29.42 |

The shopper metrics shown in TABLE III may be generated by monitoring point-of-sale systems to determine sales volumes, other systems that count shoppers, or from a company that generates statistics for a retail store or chain. The principles of the present invention may use the shopper metrics in determining placement of the electronic displays. For example, using the trip time weighted average of 29.42, a determination of the speed at which shoppers pass through the retail store and a distance traveled may be determined. In addition, as provided below in TABLE IV, an advertising wheel time may be determined.

TABLE IV
Advertising Wheel Determination

| | |
|---|---|
| Inputs | |
| Avg. Time Spent in Store (minutes) | 29.42 |
| Head of the Hour News (minutes) | 5 |
| Frequency of Ad View per Customer visit # | 3 |
| Ad Segment Time (seconds) | 5.0 |
| National Network Split | 60% |
| Local Affiliate (store/retail chain) | 40% |
| Wheel Length | |
| Gross Advertising Time per Visit (minutes) | 24.42 (Avg. Time Spent) − (Head of Hour News) |
| Net Advertising Wheel Time w/ freq = 3 (minutes) | 8.14 (Gross Advt. Time)/(Frequency of Ad View) |
| Advertising Wheel (loop) time (seconds) | 488 (Net Advt. Wheel Time) × 60 |
| Ad Avail Inventory | |
| Total Ads Available Inventory per Wheel (loop) | 98 (Advertising Wheel Time)/(Ad Time(seconds)) |
| No. National Ads Available Inventory | 59 (Total Ads Available Inventory per Wheel) × (National |
| | Network Split) |
| No. Local Ads Available Inventory | 39 (Total Ads Available Inventory per Wheel) × (Local |
| | Network Split) |

As shown in TABLE IV, the average time spent in the store (i.e., 29.42 minutes) from TABLE III is used as an input for determining a wheel time. In one embodiment, because the electronic displays are part of a network of electronic displays that have the same or similar media metrics as traditional television, a head of the hour news segment may be presented. The head of the hour news segment may be established by a network service provider/media network company or by the local affiliate (e.g., a business establishment, such as a retail store) and, in one embodiment, may be deducted from the total amount of time that the average shopper may view advertisements. As presented, the head of the hour news segment is assumed to play during the time that the average shopper is in the business establishment. In the example of TABLE IV, the head of the hour news of 5-minutes results in a gross advertising time per visit of 24.42 minutes (i.e., 29.42−5=24.42). It should be understood that if additional content is displayed that alters the amount of time that advertisements can be displayed, the gross advertising time per visit may be adjusted accordingly.

The frequency of ad view per customer visit may be established or set by the network operator or local affiliate based on media metrics that are to be achieved in the stores and the configuration of the electronic display network that is being deployed from a performance and/or cost perspective. For example, if the frequency of view is set higher (e.g., frequency value of 5), the wheel length has to be lower because an average shopper has the same limited amount of time to shop. If the frequency of view is set lower, then the wheel length is higher. The frequency of view may be set to an advertising industry accepted value, such as three, so that the electronic display network in the retail store quantifiably provides the same or similar media metrics as provided by a traditional network. In terms of being the same or similar, a few media metric parameters, such as reach and frequency may be used for the out-of-home media system. However, additional metrics that are not available in traditional television systems may also be utilized that are similar or different from traditional television and still be similar to traditional television media metrics because at least one media metric (e.g., GRP) is the same for both media networks.

Continuing with the TABLE IV, the advertising segment time may be established or set based on a variety of factors. In one embodiment, the advertising segment time may be statistically determined based on one or more parameters, including an average amount of time a shopper views an electronic display, the amount of time an electronic display is within the field-of-view of a shopper, the number of advertisements the network operator wants a shopper to view from a single electronic display, etc. Alternatively, the advertising segment time may be arbitrarily set as desired by the network operator. The advertising segment time indicates the shortest time duration of an advertisement. However, advertisements may be displayed in multiple fractions of the advertising segment time, such as two 2.5-second ads that total a full advertising segment time (e.g., 5 seconds) during the ad wheel. Furthermore, an advertiser may purchase multiple advertisement segments, consecutively (e.g., 10-second ad) or non-consecutively (e.g., three 5-second ads), during an ad wheel for the same or different advertisements.

As further shown in TABLE IV, mathematical equations are provided for computing wheel length and ad avail inventory. The net advertising wheel time varies proportionally as a function of the frequency of the ad view per customer. Setting a frequency of 3 causes the wheel time to be 8.14 minutes, while setting a frequency of 4 causes the wheel time to be 6.31 minutes, a difference of 109 seconds or 21 five-second advertisements per wheel. The difference between frequencies of 3 or 4 may impact out-of-home media network configurations and revenue. The ad avail inventory defines the number of ads available in an ad wheel. In the example provided in TABLE IV, the number of available ad segments in an ad wheel is 98, which results in 59 for the national network and 39 for the local affiliate (e.g., retail chain) using a 60/40 partition, as described above. It should be understood that the values and equations provided in TABLE IV are illustrative and that alternative values and equations may be utilized to produce the same or equivalent ability to provide an in-store electronic display network or out-of-home media network that quantifiably provides media metrics that are the same or similar as those of traditional television with which advertisers and ad agencies are accustomed to using for audience planning purposes. The media metrics provided in TABLE IV may be used in determining how to configure a network within a shopping venue to produce predicted audience reach and frequency, as further provided in TABLES V and VI.

TABLE V
Number of Electronic Displays in Shopping Venue

| | |
|---|---|
| Inputs | |
| No. of Ads Viewed per | 8 (variable by screen size, |
| Electronic Display | distance, length of ad) |
| Desired Frequency of Ad View | 3 |
| per Customer Visit | |
| Ad Time (seconds) | 5 |
| Electronic Display in | 40 (variable by screen size) |
| Field-of-View (seconds) | |
| Total Ads Available Inventory | 98 |
| per Wheel (loop) | |
| Number of Electronic Displays | |
| No. of Electronic Displays for | 12.25 (total ads available inventory per |
| 1x Frequency of View | wheel)/(no. ads viewed per screen) |
| No. of Electronic Displays for | 36.75 (37 rounded up) (no. of electronic |
| 3x Frequency of View | displays for 1x frequency of view) × |
| | (desired frequency) |

TABLE V provides an illustrative mathematical algorithm to enable computing a number of electronic displays to use in a shopping venue to achieve a certain frequency of view. The number of ads viewed per electronic display may be a function of screen size and/or resolution, distance, and ad segment time or length of ad. Screen size and/or resolution of an electronic display may be used to determine viewing distance through the use of look-up tables or graphs, as understood in the art. For example, a 6-inch screen (as measured along the diagonal) of an electronic display has an approximate 10-foot viewing distance, an 8-inch screen has an approximate 20-foot viewing distance, and a 10-inch screen has an approximate 40-foot viewing distance. The viewing distance may be different for different electronic display technologies. For example, a 6-inch LCD display may have a 10-foot viewing distance, which a 6-inch organic light emitting diode (OLED) electronic display may have a 15-foot viewing distance. Furthermore, the number of ads viewed per electronic display may be predicted based on the screen size, viewing distance, and length of ad. Speed of shoppers walking through the shopping venue may be determined by monitoring point-of-sale receipts or accessed from a company that specializes in determining speed of shoppers based on the time spent in the shopping venue and paths traveled by the shoppers while in the shopping venue. These and other customer metrics are generally available or determinable, as understood in the art.

Mathematical equations are provided in TABLE V for determining the number of electronic displays for a 1× frequency of view and 3× frequency of view. Other frequencies of view may be generated by multiplying the desired frequency by the number of electronic displays for a 1× frequency of view. It should be understood that the input variables may alternatively be output variables and solved for using the output variables as input variables (e.g., ad time determined by electronic display in field-of-view divided by number of ads viewed per electronic display).

While the number of electronic displays may be computed to provide reach to each customer or shopper in a particular shopping venue, a determination of electronic display placement or distance between electronic displays in a shopping venue may be performed to enable advertisers to be able to have a predicted frequency of ads viewed by shoppers during a shopping trip. TABLE VI provides an algorithm for determining distance between electronic displays.

TABLE VI
Electronic Display Positioning

| | |
|---|---|
| Inputs | |
| Screen size (in inches diagonal) | 10 |
| Average Viewing Distance to Screen | 40 |
| (in feet) | |
| Desired No. of Ads Viewed per Screen | 8 |
| Ad Time (seconds) | 5 |
| Avg. Customer Transit Thru Store (in feet) | 800 |
| Distance Calculation | |
| No. of Feet Between Screens | 20 (avg. customer transit |
| | through store)/(avg. viewing |
| | distance to screen) |

The example provided in TABLE VI shows how the various customer and electronic display parameters impact network operation and configuration. For example, the larger the screen size, the farther successive screens may be separated. It should be understood that the examples provided may be altered depending on the type of store in which the network of electronic displays are utilized (e.g., grocery versus clothing), time of day that the content is displayed (e.g., mid-morning versus early evening), or any other parameter that could affect customer metrics or media metrics. It should be understood that additional shopper metrics, shopping venue metrics, electronic display metrics, advertisement metrics, or other metrics may be utilized to further refine network configuration and media metrics provided by a network of electronic displays in a shopping environment.

FIG. 8B is a flow diagram of an illustrative process 810 for placing electronic displays in a retail store. The process 810 starts at step 812, where shopper metrics are obtained. As described above, shopper metrics may be obtained in a variety of ways, including visually monitoring, electronically monitoring, or otherwise. Typically, a company that assists retailers with collecting shopper metrics is used to obtain the shopper metrics. At step 814, placement locations of electronic displays in an electronic display network based on criteria to present each shopper (reach to shopping audience) with each advertisement among multiple repeating advertisements a predicted number of multiple times (frequency of ad view) as a function of the shopper metrics of the retail store may be determined.

In determining the placement locations, size of electronic displays, shopper traffic in the retail store, and so forth, may be utilized. More specifically, the placement locations may be established by determining an initial placement of an electronic display within an aisle of the retail store and each successive electronic display may be placed a certain distance D that is computed based on the various factors described above. In one embodiment, a network designer may utilize a planogram of the retail store and define placement locations for each electronic display. The planogram may be on paper or on a computer that displays an electronic version of the planogram that enables a user to position graphical elements resembling electronic displays or fixtures on gondolas or structural elements (e.g., walls) on the planogram. The computer may be configured to automatically or semi-automatically place the electronic displays on the planogram based on information input into the computer, such as screen size, shopper metrics, wheel length, etc. At step 816, the electronic displays may be installed within the retail store at the determined placement locations.

FIG. 8C is a flow diagram of an illustrative process 818 for establishing media metrics of a network of electronic displays positioned within a retail store environment that match traditional television media metrics, as understood in the art. The process 818 starts at step 820, where a store layout is obtained. The store layout may be obtained from the store itself in the form of a planogram or a store layout may be generated. In one embodiment, the store layout may be a digital representation. At step 822, shopper traffic flow patterns in the store may be analyzed. The analysis may be performed by using RFID technology for monitoring flow of shopping carts, monitoring purchased items and associating the purchased item data with a planogram, using electronic counters, or otherwise. Electronic display locations to deliver reach to each shopper may be determined at step 824. The determination may be made based on shopper traffic, size of electronic display, type of electronic display, and any other parameter that may enable a designer to locations with the store to place the electronic displays to ensure that substantially every shopper has the ability to view the electronic displays for a certain duration of time. Steps 820-824 establish audience reach for the network of electronic displays in the store.

At step 826, an ad segment time is selected. In one embodiment, the ad segment time may be set at 10 seconds to match certain traditional television advertising spot times, thereby enabling advertisers to use advertisements in both media (i.e., traditional television and out-of-home television networks). At step 828, selection of a predicted number of multiple times (i.e., frequency) for each shopper to view an advertisement in the store (i.e., reach) be made. In one embodiment, the frequency may be selected as a value of three (3) to match traditional gross rating points that are utilized in traditional broadcast media. Steps 826 and 828 establish frequency for each shopper to view an advertisement a particular number of times.

At step 830, a determination of an average shopping trip time for shoppers at the store is made. The determination may be provided by a third party or measurement may be made using RFID tagged shopping carts or otherwise may be made. At step 832, a wheel length may be determined as a function of frequency and average shopping trip time. Steps 830 and 832 are used to determine wheel length that delivers a certain frequency to the established teach of the audience at the store. The established reach is generally 100 percent of the shoppers that enter the store who shop for the average shopping trip time. Shoppers who shop for less time than the average shopping trip time typically view each advertisement fewer than the established frequency, and shoppers who shop for more time than the average shopping trip time typically view each advertisement higher number of times than the established frequency.

At step 834, media metrics of the network of electronic displays may be computed. The media metrics may include gross rating points (GRP) on a daily basis or weekly basis, cost per thousand views (CPM), and other media metrics that are generally used by traditional television networks to sell and determine a cost for advertising on the television networks. At least one of the media metrics, such as GRP, matches traditional media metrics so that purchasers of airtime on the out-of-home television network (i.e., network of electronic displays in the store) can directly compare viewership between traditional in-home and out-of-home television networks. At step 836, airtime on the out-of-home television network may be sold to advertisers.

As provided above, an in-store electronic display network or out-of-home television network in a shopping venue may be configured to provide predictable and quantifiable media metrics that are the same or similar to media metrics of traditional television networks. Being able to predict reach and frequency within retail locations enables the network operator to provide advertisers with traditional television media metrics for the out-of-home television network, thereby enabling the network operator to establish relationships with media planners, ad agencies, and retail store chains in providing an out-of-home television network in shopping venues as further described above. Because media planners and ad agencies understand traditional media metrics, purchasing airtime on the television network in shopping venues may be performed by traditional television media buyers without having to significantly alter their paradigms.

Because the network operator of the out-of-home television network can offer quantifiable media metrics that are the same or similar to media metrics of traditional television networks, airtime of traditional in-home television and out-of-home or in-store television networks may be packaged and offered to advertisers. Because the size of audiences of the in-store television network is generally significantly larger than individual television networks due to fragmentation in television and vast number of shoppers at retail stores, a traditional television network may offer its advertisers the ability to co-advertise on the in-store television network and vice versa.

TABLE VII shows an exemplary packaged advertising sales sheet that includes pro forma information for both the traditional in-home television network and in-store television network. Because the audience of the out-of-home television network is so much larger, the CPM (i.e., cost per thousand viewers) may be lower. The reverse may alternatively occur, where the larger audience may cause an increase in demand for a limited ad avail during an ad wheel. As shown in TABLE VII, an advertiser may receive a blended rate to bring the overall cost of television advertising, both in-home (traditional) and out-of-home television, lower.

TABLE VII
Packaged Advertising Costs for Traditional Television
and Out-of-Home Television

| Traditional Television | |
|---|---|
| Per spot delivery | 500,000 |
| Per spot delivery (000) | 500 |
| No. spots per day | 3 |
| Weekly schedule (total # spots) | 7 |
| Total impressions (000) | 10,500 |
| CPM (avg.) | $20 |
| Per spot cost | $10,000 |
| Total cost of schedule | $210,000 |
| Out-of-Home Television | |
| Per spot delivery | 2,688,000 |
| Per spot delivery (000) | 2,688 |
| No. spots per day | 3 |
| Weekly schedule (total # spots) | 21 |
| Total impressions (000) | 56,448 |
| CPM (avg.) | $5.00 |
| Per spot cost | $13,440 |
| Total Cost of schedule | $282,240 |
| Package Deal | |
| Package Impressions | 66,948 |
| Package Cost | $492,240 |
| Package CPM | $7.35 |

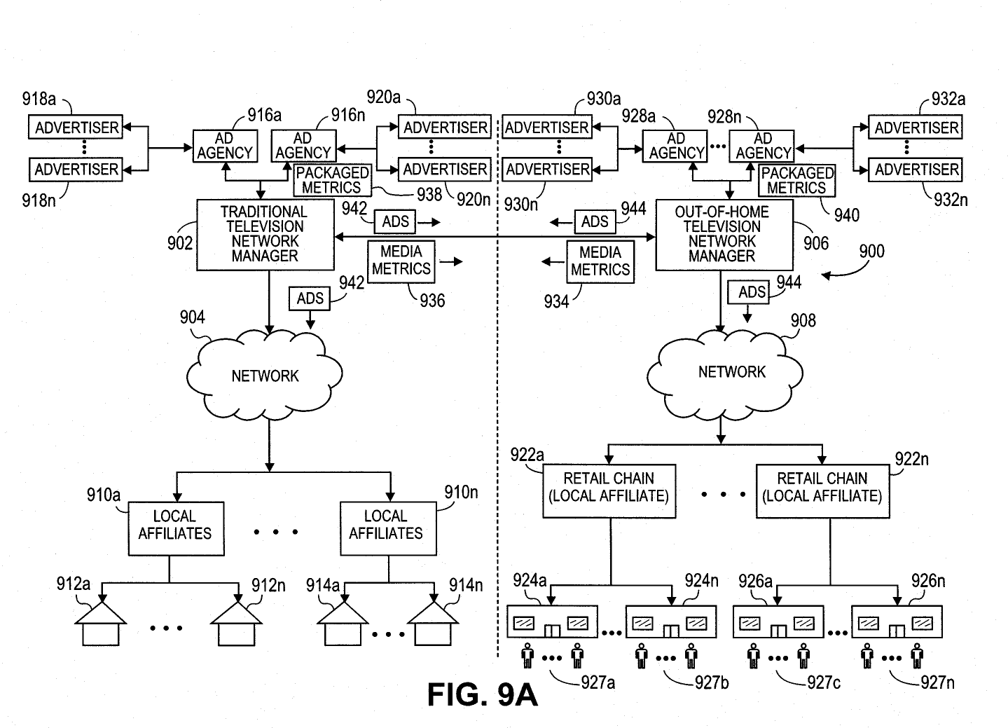

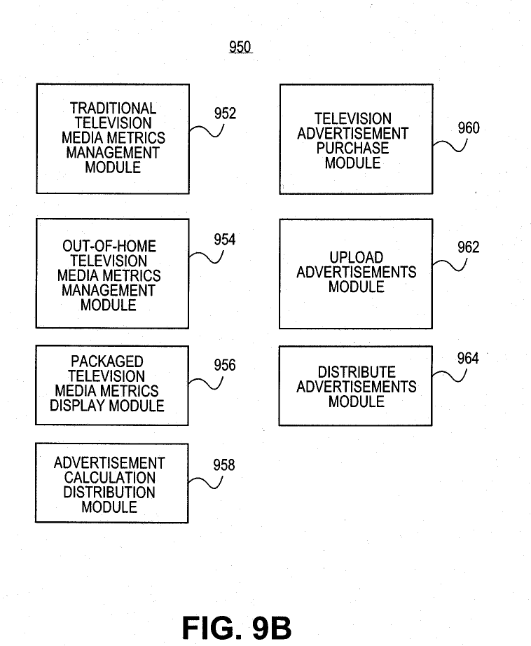

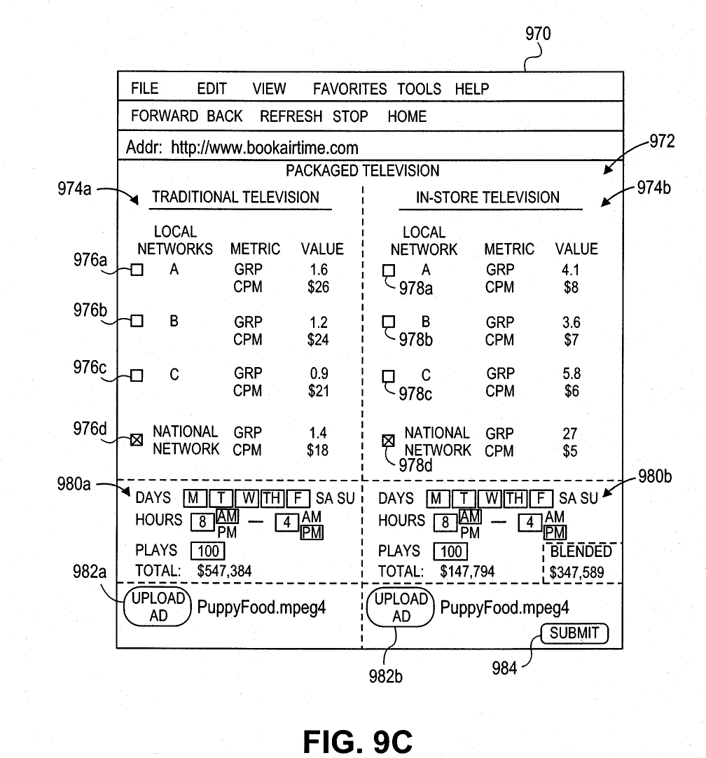

FIG. 9A is a block diagram of traditional and out-of-home television networks 900. A traditional television network manager 902 may manage and operate a television network 904, while an out-of-home television network manager 906 may manage and operate an out-of-home television network 908 in shopping venues. As understood in the art, the traditional television network manager 902 may have local affiliates 910a-910n (collectively 910) that operate in local markets (e.g., cities) to distribute network broadcasts to households 912a-912n and 914a-914n, respectively. The network manager 902 and local affiliates 910 traditionally partition airtime such that the network manager 902 and local affiliates 910 each have a percentage of the airtime (e.g., 60%/40% partition). The network manager 902 may sell the airtime to ad agencies 916a-916n (collectively 916) or media planners/buyers (not shown) who purchase airtime for the ad agencies 916. The ad agencies 916 sell the airtime on the traditional television network to advertisers 918a-918n and 920a-920n, such as product manufacturers and service providers.

Similarly, the out-of-home television network manager 906 may have retail chain local affiliates 922a-922n (collectively 922) that operate retail stores 924a-924n (collectively 924) and 926a-926n (collectively 926), respectively. Each of the retail stores 924 and 926 have customers 927a-927n (collectively 927) who visit the retail stores 924 and 926. The network manager 906 may sell the airtime to ad agencies 928a-928n (collectively 928) or media planners/buyers (not shown) who purchase airtime for the ad agencies 928. The ad agencies 928 sell the airtime to advertisers 930a-930n and 932a-932n, which may be the same or different than advertisers 918a-918n and 920a-920n. The airtime may be filled with advertisements for the customers 927 to view on the out-of-home television network.

Because the out-of-home television network manager 906 is able to quantitatively generate the same or similar media metrics as the traditional television network manager 902, each may share respective media metrics 934 and 936 that include GRP, which is a function of reach and frequency of respective television networks. The media metrics of each network manager 902 and 906 may be combined into packaged metrics 938 and 940 in the form of sales sheets or otherwise (e.g., webpage) by the traditional television network manager 902 and sales sheet by the out-of-home television network manager 906 and provided to the ad agencies 916 and 928, respectively, to sell airtime on both networks 904 and 908 to advertisers 918, 920, 930, and 932. Again, because the media metrics are the same or similar for in-home and in-store television networks, the advertisers are willing to purchase airtime on both networks without having to alter their paradigm.

More particularly, by packaging the in-home and out-of-home television airtime, advertisers may directly compare the CPM between the different networks and make audience planning decisions as to where to spend ad budget money. Furthermore, although not provided by the numbers, it is understood by advertisers that advertising in retail stores can influence buyers more than on traditional television to purchase products due to the advertisements being at or near the actual products available for shoppers to purchase. In the example of TABLE VII, an advertiser may spend more money for the out-of-home television advertisement, but less on a CPM basis. The advertiser is able to save $12.65 on a CPM basis to reach the same audience by purchasing airtime on the out-of-home television network. Furthermore, because demographics can be determined for the out-of-home television network for particular retail chains, based on location of store, loyalty card information, different times of the day, and so forth, advertisers are provided with the same or similar flexibility in reaching an audience with demographics that the advertiser desires. In the example of TABLE VII audience delivered to cable television is based on a sampling, while audience delivered to an out-of-home television network is measured by cash register receipts.

In selling the airtime to the advertisers 918, 920, 930, and 932, each of the network managers 902 and 906 may communicate ads 942 and 944, respectively, purchased to the other network manager 906 and 902, respectively, for distribution over the other's network 908 and 904, respectively. For example, if a traditional television network, such as CNN®, packages media metrics for its television network and in-store television network, advertising space on both networks may be sold to advertisers. Although the ad spots may have different formats (e.g., 30-seconds on the traditional television network versus 10-seconds on the out-of-home television network), the media metrics for the combined advertisement distribution may benefit the advertisers by lowering CPM average cost to reach a desired audience. However, with a recent shift by television networks offering 10 second ad spots, the out-of-home television network manager 906 may offer the same 10 second ad spots, thereby simplifying advertising efforts for the advertisers 918, 920, 930, and 932.

One embodiment of a retail store may include product displays located throughout a floor, where the product displays have products available for purchase by shoppers. An in-store television network may include multiple electronic displays interspersed throughout the product displays. The in-store television network may have media metrics that are substantially the same as a traditional television network. In being substantially the same, the media metrics may include predictable audience reach and frequency of view of advertisements in an advertising wheel to enable advertisers to interpret the media metrics in the same or similar manner as performed for traditional television networks.

FIG. 9B is a block diagram depicting illustrative modules 950 for packaging media metrics of traditional and out-of-home television networks. The modules 950 may be executed on one or more computing systems, such as servers operated by the traditional television network manager 902 (FIG. 9A) and out-of-home television network manager 906. The modules 950 may alternatively be operated on a computing system of an ad agency that purchases airtime for advertisers. In one embodiment, the computing systems that executed the software are in communication with the Internet or other wide area network and capable of enabling a purchaser of airtime to purchase airtime and upload advertisements via the network. Each of the network managers 902 and 906, as previously described, distribute media metrics to one another. By sharing the media metrics of the respective networks, the modules 950 may utilize those media metrics for packaging and presenting to advertisers when selling airtime on respective networks, thereby providing for cross-selling opportunities for the network managers 902 and 906.

A traditional television media metrics management module 952 may be configured to collect and manage media metrics for a traditional television network (e.g., CBS®, CNN®, and FOX® television networks). The traditional media metrics may include GRPs, CPM, viewership, and any other media metrics, as understood in the art. The management module 952 may store the media metrics locally or be configured to remotely access the media metrics stored by the traditional television network manager or a third party.

An out-of-home television media metrics management module 954 may be configured to collect and manage media metrics for an out-of-home television network. The out-of-home television network may be deployed within retail and other out-of-home environments, and that is configured to provide for at least one media metric that matches traditional media metrics. For example, the media metrics may include GRP and CPM, thereby enabling an advertiser to compare prices on each of the television networks. Because media metrics in the out-of-home environments, particularly in retail stores, can be quantified, the media metrics in the out-of-home environments may be more precise than those estimated by traditional television media metrics standards, but the media metrics in the different television platforms are considered to match nonetheless.

A packaged television media metrics display module 956 may be configured to interface with modules 952 and 954 and display media metrics that include both traditional and out-of-home television network(s). One embodiment of packaged and displayed media metrics is shown in TABLE VII. The media metrics may be displayed on a single page, such as a webpage. In one embodiment, the media metrics may be displayed in a table format. Various parameters may be displayed for an airtime purchaser to select national network or local network, including DMA, local affiliates, dates, times, desired GRPs, impressions, and other parameters, as understood in the art. The out-of-home television network(s) may be shown to include national network, local network, one or more different local affiliates (i.e., chain retail stores) that are selectable by an advertiser. In being selectable, the advertiser may select a DMA in which to advertise and stores within the DMA may be included in the media metrics. Alternatively and/or additionally, the advertiser may select one or more particular retailers within which the advertiser desires to display an advertisement. The module 956 may be located on a network server or at a computing device of a purchaser of airtime.

A calculate advertisement distribution module 958 may be configured to receive selections of airtime for displaying advertising content and calculate a price for the selection. The selections of airtime may include a variety of national network and local network parameters, such as DMA, dates, times, local network affiliates, and other parameters, as understood in the art. If the advertiser selects airtime on both traditional and out-of-home television networks, the module 958 may compute a blended rate based on the selected airtime on each network. For example, if the airtime selection is an equal split on the traditional television network is $26 CPM and the airtime selection on the out-of-home television network is $8 CPM, then the packaged CPM displayed for the advertiser will be $17 CPM. The modules 956 and 958 may communicate with one another, thereby enabling the purchaser of airtime to change selections and view updated prices for advertising. In one embodiment, the module 958 may compute and display the price. Alternatively, the price may be computed by the module 958 and communicated to the module 956 for display.

A television advertisement purchase module 960 may be configured to receive actual purchases for the airtime and to reserve the airtime for the advertisers. If the airtime purchases are made on both traditional and out-of-home television networks, the purchases are shared to both network managers 902 and 906.

An upload advertisements module 962 may be configured to enable an advertiser or its agent to upload and store one or more advertisements, as understood in the art, while purchasing airtime on the traditional and out-of-home television networks. In uploading the advertisements, the computing system may enable a user to upload a single advertisement if the advertisement is to be distributed to both television networks (e.g., 10 second advertisement for distribution to both television networks). Alternatively, the advertisements may be different for distribution to the different television networks. The module 962 may be configured to verify that the format of the uploaded advertisements is correct (e.g., .mpeg4 video file format).

A distribute advertisements module 964 may be configured to distributed the uploaded advertisements to respective network managers 902 and 906 for distribution to local affiliates of each of the respective network managers 902 and 906. The module 964 may access playlist(s) being managed by each of the network managers 902 and 906 and include identifiers (e.g., names of video files for advertisements) in time slots for approval by the network managers 902 and 906 and, optionally, local affiliates, prior to distribution to the local affiliates for displaying the advertisements.

FIG. 9C is a screen shot 970 of an illustrative graphical user interface 972 for a purchaser of airtime to view media metrics on traditional television and out-of-home television networks, select airtime, price the airtime, and upload an advertisement. In one embodiment, at least a portion of the modules 950 described in FIG. 9B may be utilized to operate the GUI 972. The GUI 972 may include a traditional television portion 974a and in-store television portion 974b to show both local and national network airtime purchasing opportunities for airtime purchasers (e.g., advertising agencies). The traditional or in-home television portion 974 may include national network or a list of local networks or local network affiliates (e.g., Chicago affiliate of FOX®) that service particular DMAs, as understood in the art, and national network. The list may include media metrics, such as GRP, impressions, and CPM, and associated values as determined by a media rating service, such as Nielsen. For example, a Traditional Television Local Network A delivers a GRP of 2 at a CPM of $26. The Traditional Television National Network delivers a GRP of 1 at a CPM of $18. In-Store Television Local Network C delivers a GRP of 5 at a CPM of $6. The GRP delivery of in-store television networks may be significantly higher than GRP delivery of traditional television because, in the case of grocery stores, every television viewing household needs to purchase food and there is a limited number of grocery store shopping venues as compared to today's vast number of television channels. By packaging the media metrics of traditional and in-store television networks, buyers of airtime can readily compare the media metrics when making airtime purchasing decisions. A purchaser of airtime may select check-boxes 976a-976d to purchase airtime on any of the traditional television networks and/or check-boxes 978a-978d to purchase airtime on any of the in-store television networks.

The GUI 972 may also include airtime sections 980a and 980b that provide selectable graphical user elements for selecting days, hours, number of plays, and any other parameter for displaying advertisements on the traditional and in-store television networks. A total price for airtime purchases on each of the networks with the same airtime purchase parameters is shown. As expected, the airtime purchase cost on the traditional television network is significantly higher than that of the in-store television network due to the lower audience delivery of traditional television audience and generally higher CPMs while in-store television can deliver higher audience and lower CPMs.

If the purchaser of airtime decides to purchase airtime on either or both of the traditional and in-store (i.e., out-of-home) television networks, then the purchaser may upload an advertisement in the form of an mpeg file by selecting “upload ad” soft-buttons 982a and 982b. Once the purchaser has selected the network(s) and airtime parameters, and uploaded the advertisement(s), the purchaser may select the “submit” soft-button 984.

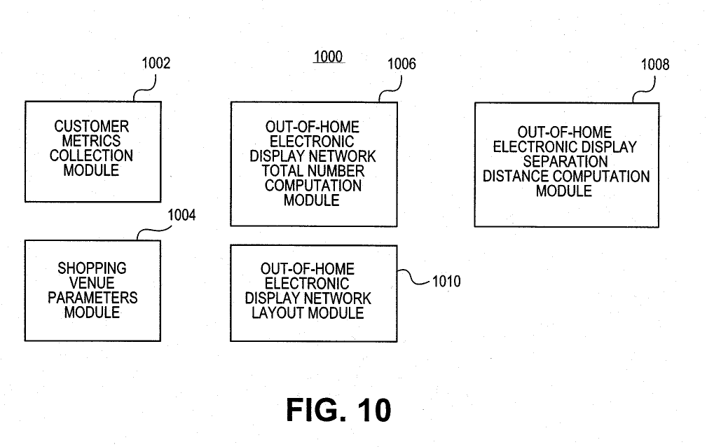

FIG. 10 is a block diagram depicting exemplary modules 1000 for enabling an out-of-home electronic display network to be configured to provide predictable media metrics. One module may include a customer metrics collection/computation module 1002 that collects customer or shopper metrics of a shopping or other venue. The module 1002 may collect customer metrics by accessing a database, receiving the customer metrics in a spreadsheet, interface with a system that automatically or manually collects customer metrics, or though any other technique as understood in the art. The customer metrics may include data that describes how many customers enter or exit a shopping venue, purchase one or more products at the shopping venue, actual or average duration of time that each shopper is at the shopping venue, average speed of a shopper walking through the shopping venue, pathways taken while at the shopping venue, or any other customer metric that may be utilized for configuring an out-of-home electronic display network. Traffic flow or pathway metrics at a shopping venue may enable the electronic displays to be positioned in locations to maximize potential view and audience reach of the electronic displays.

A shopping venue parameters module 1004 may be configured to access or otherwise receive parameters of a shopping venue. The shopping venue parameters may include a floor plan, planogram, configuration, images, or any other information of a shopping venue that may be utilized for configuring an out-of-home electronic display network.

An out-of-home electronic display network total number computation module 1006 may include one or more mathematical equations that utilize the customer metrics and shopping venue parameters to determine a total number of out-of-home electronic displays to be positioned in a shopping venue to provide a certain audience reach to shoppers in a shopping venue and frequency of view of advertisements or messages. In one embodiment, the module 1006 includes mathematical equations provided in TABLE V.

An out-of-home electronic display network separation distance computation module 1008 may include one or more mathematical equations that utilize the customer metrics, shopping venue parameters, and number of electronic displays in a shopping venue to determine a separation distance of each electronic display along a pathway to provide predictable reach and frequency of advertisements displayed on the electronic displays. The module 1008 may include mathematical equations provided in TABLE VI.

An out-of-home electronic display network layout module 1010 may be configured to generate numerical, graphical, or pictorial representations of a shopping venue for a network manager to position the electronic displays in the shopping venue based on the number of electronic displays and separation distance between electronic displays. The layout module 1010 may provide a graphical user interface to automatically or manually allow someone to design or otherwise configure the electronic displays in the shopping venue.

Although described as being separate modules 1000, the principles of the present invention may alternatively have a one or more modules that include the same or similar functionality as provided in the modules 1000. In one embodiment, modules 1002-1008 may be equations in cells of a spreadsheet and the spreadsheet may provide for the functionality of module 1010 to produce a graphical representation of the shopping venue. Alternatively, a separate software program, such as a graphical layout program, may provide for the graphical representation of the shopping venue to position the electronic displays. The modules may be the software 406 (FIG. 4) executed on the processor 404 in server 402. Alternatively, another computer, such as a personal computer, may be utilized to execute the modules 1000.

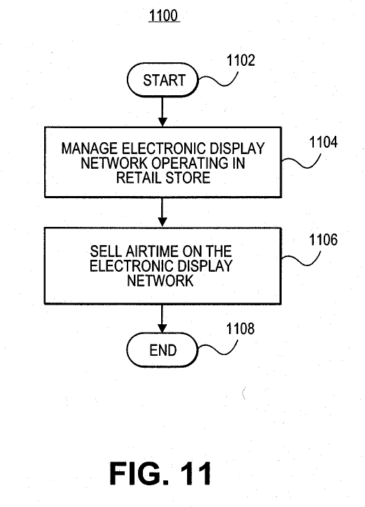

FIG. 11 is a flow diagram describing a process 1100 for selling airtime. The process 1100 may start at step 1102. At step 1104, the process 1100 may include managing an electronic display network operating in a retail store. The network may include electronic displays interspersed among product displays and arranged to present a shopper with each advertisement among multiple repeating advertisements a predicted number of multiple times as a function of shopper metrics and a configuration of the electronic display network during a shopping trip in the retail store. In being interspersed among product displays, the electronic displays may be positioned along pathways that include products being displayed for purchase by shoppers. The multiple repeating advertisements may be in an advertising wheel. At step 1106, airtime on the electronic display network may be sold. In one embodiment, the airtime may be sold to an advertiser for an advertisement to be displayed on the electronic display network. The process 1100 ends at step 1108.

In managing the electronic display network, a manager of the electronic display network may access shopper metrics including a statistical value of an average time for an average shopping trip. The electronic display network may be operated by a shopping venue, such as a retail store. The shopper metrics may be computed as a function of a configuration of the retail store. Advertisements may be communicated to the retail store for display on the electronic displays. A length of time for the multiple repeating advertisements to repeat may be determined, where the length of time may be used to predict a frequency for each shopper to view advertisements on the electronic displays during a single shopping trip. An advertisement segment time may be established for each advertisement to be displayed for at least one advertisement segment time. In one embodiment, the advertisement segment time may be 10 seconds or less. In addition, a spacing distance between each of the electronic displays may be determined to ensure entire audience reach or that the shopper has the opportunity to view an electronic display for a predicted duration of time while shopping. A gross rating point, which is computed as reach times frequency, may be determined as a metric for use in billing advertisers for placing advertisements on the electronic display network. Furthermore, airtime for display of advertising may be partitioned for a network manager/media company and an operator of the retail store. In one embodiment, the network manager is a national network manager and the operator of the retail store is a local affiliate of the network manager. If the operator of the retail store is a retail chain, then each of the retail stores of the retail chain may be part of the local affiliate.

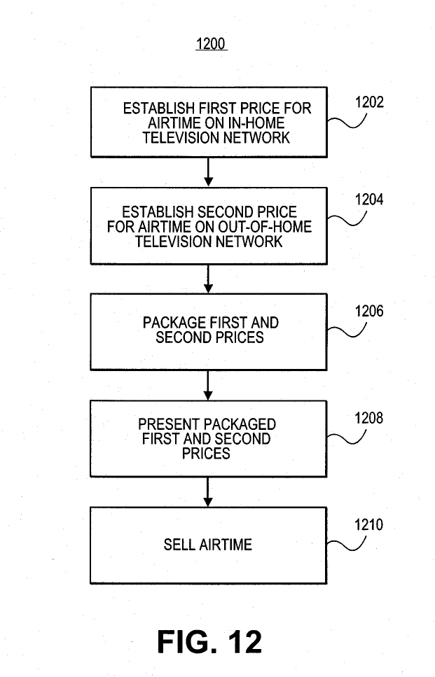

FIG. 12 is a flow diagram of an exemplary process 1200 for selling airtime for advertising. At step 1202, a first price for airtime to broadcast advertisements on a first television network on which television programs are played may be established. The first television network may be a predominantly in-home television network. A second price may be established at step 1204 for airtime to broadcast advertisements on a second television network. The second television network may be a predominantly out-of-home television network, such as an in-store electronic display network. The first price may be established based on an estimated first audience reach determined to be watching the first television network during a first time period, and the second price may be established based on an estimated second audience reach determined to be watching the second television network during a second time period. At step 1206, the first and second prices may be packaged for potential advertisers to purchase airtime over the first and second television networks. The packaged first and second prices may be presented to advertisers at step 1208. Additionally, the first and second audience reach may be presented to the advertisers. Furthermore, any media metric associated with either or both of the first and second television networks may be presented. In presenting the first and second prices, the prices may be communicated to advertisers via a communications network, such as via an email, website, or otherwise as understood in the art. The second price may be based on an audience being predominantly located within retail venues. At step 1210, the airtime may be sold to an advertiser to broadcast an advertisement over the first and second television networks. Once the airtime is sold, a purchaser of the airtime or agency may provide advertising content for distribution to a network of in-store electronic devices for display.

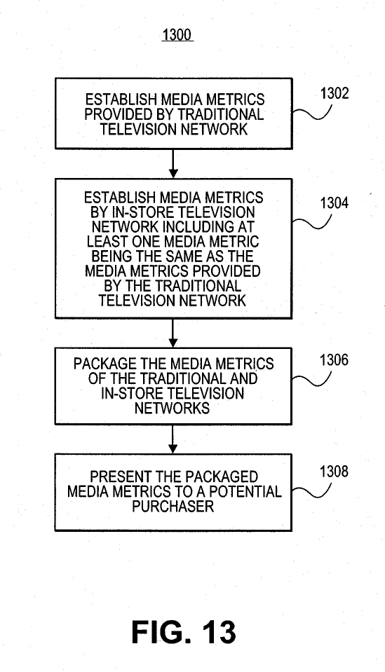

FIG. 13 is a flow diagram of an exemplary process 1300 for selling television media airtime. The process 1300 may start at step 1302, where media metrics provided by a traditional television network may be established. Establishing the media metrics may be performed by accessing the media metrics in a database or otherwise entering the media metrics into a software program, such as a spreadsheet. At step 1304, media metrics provided by an in-store television network may be established, where the media metrics for the traditional television network and in-store television network may include at least one of the same parameters (e.g., gross rating points, impressions, CPM). The media metrics for the in-store television network may be established in the same or similar manner as establishing the traditional television network media metrics. The media metrics of the in-store television network may be media metrics defined by an electronic display network deployed in a retail store of a retail store chain. The media metrics of the traditional and in-store television networks may be packaged at step 1306, and presented to a potential purchaser at step 1308. In one embodiment, the potential purchaser may be a potential advertiser. Alternatively, the potential purchaser may be an ad agency or media planner. In presenting the packaged media metrics, the media metrics for the traditional television network and in-store television network may be displayed on a webpage. Airtime may be sold to the potential purchaser for advertising on the traditional and in-store television networks, thereby costing a blended rate (i.e., an average rate based on the cost of airtime of each network and airtime purchased on respective networks).

Although the in-store or out-of-home media networks have been primarily described in relation to being deployed in retail stores, the principles of the present invention may be utilized in alternative locations, including mall pathways, streets, store windows, airports, casinos, sports venues, transportation vehicles (e.g., trains) or any other venue that has a customer population that can provide predictable and quantifiable media metrics.

The previous detailed description of a small number of embodiments for implementing the invention is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method of manufacturing an electronic display network in a retail store for presenting advertisements to customers, comprising:
interspersing electronic displays among product displays in the retail store; and
arranging the electronic displays to present a shopper during a shopping trip in the retail store with each advertisement among multiple repeating advertisements displayed on the electronic displays located throughout the retail store a predicted number of multiple times.

2. The method according to claim 1, wherein arranging the electronic displays includes arranging the electronic displays as a function of shopper metrics of the retail store and size of the electronic displays.

3. The method according to claim 1, further comprising accessing shopper metrics including a statistical value of an average time for an average shopping trip.

4. The method according to claim 1, further comprising determining a length of time for the multiple repeating advertisements to repeat, wherein the length of time defines a length of time of an ad wheel.

5. The method according to claim 1, further comprising establishing an advertisement segment time for each advertisement to be displayed for at least one advertisement segment time.

6. The method according to claim 1, further comprising determining a spacing distance between each of the electronic displays to ensure that the shopper has the opportunity to view an electronic display for a predicted duration of time while shopping.

7. The method according to claim 1, further comprising determining a gross rating point based on the configuration of the electronic displays and shopper metrics, the gross rating point being used in billing advertisers for placing advertisements on the electronic display network.

8. The method according to claim 1, further comprising partitioning available advertising airtime on the electronic display network with an operator of the retail store.

9. The method according to claim 1, further comprising selling airtime on the electronic display network.

10. The method according to claim 1, further comprising configuring a computing system to be in communication with each of the electronic displays and distributes at least one playlist and advertisements to the electronic displays for display on the electronic displays according to the at least one playlist.

11. The method according to claim 10, wherein the at least one playlist is synchronized on each of the electronic displays.

12. An electronic display network, comprising:
a plurality of electronic displays interspersed among product displays in a retail store, said electronic displays being arranged to present a shopper an advertisement from among multiple repeating advertisements displayed on said electronic displays a predicted number of multiple times; and
a computing system in communication with each of said electronic displays, and configured to communicate the advertisements to said electronic displays.

13. The electronic display network according to claim 12, wherein said computing system is local to the retail store; and
further comprising a remote computing system configured to generate at least one playlist for playing the advertisements on said electronic displays at the retail store, wherein the at least one playlist is configured to include advertisement segment times form a total playlist time that, when the advertisements are played on said electronic displays, enable the shopper to view each advertisement the predicted number of multiple times, and wherein said remote computing system is further configured to communicate the at least one playlist and advertisements to said computing system.

14. The system according to claim 12, wherein the shopper is an average shopper as determined by shopper metrics of the retail store.

15. The system according to claim 12, wherein successive electronic displays of said electronic displays are separated by a distance D that is a function of viewing distance of the successive electronic displays such that the viewing distance enables the shopper to view the advertisement the predicted number of multiple times.

16. A method for selling airtime for advertising, said method comprising:
establishing a first price for airtime to broadcast advertisements on a first television network on which television programs are played, the first television network being a predominantly in-home television network and having first media metrics associated therewith;
determining second media metrics of a second television network, the second television network being a predominantly out-of-home television network, the second media metrics including at least one media metric parameter that matches the first media metric;
establishing a second price for airtime to broadcast advertisements on the second television;
packaging the first and second prices and the at least one media metric for potential purchasers to purchase airtime of the first and second television networks;
presenting the packaged first and second prices and at least one matching media metric to a potential purchaser of the airtime; and
selling the airtime to a purchaser to advertise on the first and second television networks.

17. The method according to claim 16, wherein establishing a first price for airtime is based on an estimated first audience reach determined to be watching the first television network during a first time period;
wherein establishing a second price for airtime is based on an estimated second audience reach determined to be watching the second television network during a second time period; and further comprising presenting the first and second audience reach to the potential purchasers.

18. The method according to claim 16, wherein presenting the first and second prices includes communicating the first and second prices to potential purchasers over a communications network.

19. The method according to claim 16, further comprising computing a total cost for airtime sold to advertise on the first and second television networks.

20. The method according to claim 16, wherein establishing the second price for airtime to broadcast advertisements on the second television network includes establishing the second price for airtime to broadcast advertisements on the second television network having an audience being predominantly located within retail venues.

21. A system for selling television airtime, said system comprising:
a traditional television media metrics management module configured to manage media metrics of a traditional television network;
an out-of-home television media metrics management module configured to manage media metrics of an out-of-home television network, at least one media metric of the traditional television network matching a media metric of the out-of-home television network;
a packaged television media metrics display module configured to display the at least one media metric for the traditional and out-of-home television networks for a potential purchaser of airtime to view;
an advertisement calculation distribution module configured to receive selected airtime purchase parameters and compute a price for the selected airtime; and
a television advertisement purchase module configured to receive and book airtime purchases on the traditional and out-of-home television networks.

22. The system according to claim 21, wherein the out-of-home television media metrics are media metrics determined to be provided by a network of electronic displays arranged to present a shopper an advertisement from among multiple repeating advertisements displayed on the electronic displays a predicted number of multiple times.

23. The system according to claim 21, wherein said packaged television media metrics display module is configured to display the at least one media metric for the traditional and out-of-home television networks is displayed on a webpage.

24. The system according to claim 21, wherein said advertisement calculation distribution module is configured to compute a blended rate for advertising on both the traditional and out-of-home television networks.

25. A retail store, comprising:
product displays located throughout a floor, said product displays having products available for purchase; and
an in-store television network including a plurality of electronic displays interspersed throughout the product displays, said in-store television network having at least one media metric that is substantially the same as a media metric of a traditional television network.

26. The retail store according to claim 25, wherein each of the electronic displays are interspersed throughout the product displays and positioned in a field-of-view of a shopper.
